(19) United States
(12) Patent Application Publication
(10) Pub. No.: US 2004/0264961 A1
(43) Pub. Date: Dec. 30, 2004

(54) Ethernet passive optical network system, and optical network terminal and optical line terminal provided in the same

(76) Inventors: Hong Soon Nam, Daejeon (KR); Tae Joon Park, Daejeon (KR); Kwang Soo Cho, Daejeon (KR); Yong Tae Kim, Daejeon (KR); Heyung Sub Lee, Daejeon (KR); Hyeong Ho Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,000

(22) Filed: Jun. 10, 2004

(30) Foreign Application Priority Data
Jun. 12, 2003 (KR) 2003-37791
Jul. 26, 2003 (KR) 2003-51834

(51) Int. Cl. H04B 10/20

(52) U.S. Cl. 398/58

(57) ABSTRACT

The present invention relates to an Ethernet Passive Optical Network (EPON), which provides high-speed data communication services and voice services over the EPON, thus integrating subscriber access networks into a single access network. In the network system of the present invention, with respect to upstream data connected to a subscriber, codes analog signals into digital signals and convert digital signals into packets in the form of Ethernet frames, converts TDM data into Ethernet frames, attaches the MAC address of a TDM port at the end of an optical cable to the Ethernet frames and then transmits the Ethernet frames to the EPON, switches received data depending on Ethernet MAC addresses, converts TDM data and interfaces the converted TDM data with the local exchange.

### BACKGROUND OF THE INVENTION

1. Field of the Invention

The present invention relates to an optical network terminal and an optical line terminal of an Ethernet passive optical network, which allows the Ethernet passive optical network to accommodate together high-speed data traffic and time division multiplexing traffic, thus integrating a subscriber access network for a packet data service and a subscriber access network for a plane old telephone service or time division multiplexing leased line service into a single subscriber access network.

2. Description of the Related Art

Currently, as optical transmission technology has been developed and subscriber traffic has rapidly increased, Fiber To The Curb (FTTC) or Fiber To The Home (FTTH) referring to the installation of optical fibers near or up to the homes of subscribers has been popularized, and optical cables have been gradually extended to even subscriber terminals.

Because the transmission quantity of such an optical cable is much greater than a bandwidth actually required by each subscriber, a Passive Optical Network (PON) shared among a plurality of subscribers through a splitter has been developed.

PONs are classified into, for example, an Asynchronous Transfer Mode (ATM) PON (APON) when accommodating an ATM protocol, an Ethernet PON (EPON) when accommodating an Ethernet protocol, and a GPON when accommodating together the ATM protocol and the Ethernet protocol, according to used protocols.

Of the above PONs, an EPON (defined by Glen Kramer and Gerry Pesavento in a publication entitled “Ethernet Passive Optical Network (EPON): Building a Next-Generation Optical Access Network” in IEEE Communication Magazine, February, 2002) is constructed so that an Optical Line Terminal (OLT), connected to a network, interfaces with a plurality of Optical Network Terminals (ONTs) (also referred to as Optical Network Units: ONUs) through a splitter, and an OLT functioning as a master of EPON Media Access Control (MAC) and an ONT functioning as a slave thereof are connected to each other using an optical cable, thus performing a point-to-multipoint communication therebetween.

However, an EPON system, which is based on the Ethernet, is operated at high speeds and has a high bandwidth availability ratio, but it has delays and large delay variations, so that there is required a separate leased line subscriber access network for the subscribers of high quality Time Division Multiplexing (TDM) leased lines.

For other proposed conventional technologies in addition to the above PON technology, there is technology disclosed in U.S. Pat. No. 6,459,708 entitled “Apparatus and method for providing T1/E1 telecommunications trunks over IP networks” by Toledo Communications, Inc, US. In this patent, E1/T1 data are converted into packets and transmitted through a high speed Internet Protocol (IP) network, instead of a Public Switched Telephone Network (PSTN), so as to transmit T1/E1 trunk data through the IP network. According to the method and apparatus, there is an advantage in that E1/T1 trunk data are transmitted through the IP network to provide a single pseudowire edge-to-edge emulation function, but there is a problem in that, since routing is executed through the Internet instead of the PSTN, services provided through the conventional PSTN cannot be provided, delays and delay variations are large, and clock synchronization between terminals is difficult, so that it is difficult to accommodate TDM subscribers.

Further, for clock synchronization technologies, there are schemes, such as a scheme of utilizing a Phase Locked Loop (PLL) disclosed in U.S. Pat. No. 6,470,032 entitled “System and method for synchronizing telecom-related clocks in Ethernet-based passive optical access network” by Alloptic, Inc, US, an adaptive clock recovery scheme disclosed in U.S. Pat. No. 6,252,850 entitled “Adaptive digital clock recovery” by LSI Logic Corporation, and a scheme of utilizing a frequency locked loop. However, since a TDM service through the EPON requires inexpensive and precise clock synchronization technology, those conventional schemes are not suitable for the TDM service.

FIG. 1 is a view showing the construction of a conventional subscriber access network having the above construction, in which subscribers may include a normal subscriber, a Very-High-Data-Rate Digital Subscriber Line (VDSL) subscriber, a TDM leased line subscriber, and the like.

As shown in FIG. 1, the terminal 11a of the TDM leased line subscriber communicates with a Local Exchange (LE) 16 through a Private Automatic Branch Exchange (PABX) 13 and a T1/E1 subscriber line. A normal public telephone terminal 11b, having subscribed to an analog telephone service (hereinafter referred to as a “Plain Old Telephone Service: POTS”), communicates with the local exchange 16 through an analog subscriber line. Therefore, the terminals 11a and 11b are provided with communication services while being separated from a FTTC or FTTH network for the high-speed Internet.

Further, the normal telephone terminal 11c of the VDSL subscriber and a VDSL terminal 12a equipped with a modem (not shown) use different bands through a VDSL splitter 14 and then share a single VDSL subscriber line. Further, at the end of the VDSL subscriber line, a Digital Subscriber Line Access Multiplexer (DALAM) 15 is installed and connected to the local exchange 16 of the PSTN and the OLT 18 of a Packet Switched Data network/Internet Protocol (PSDN/IP, also referred to as the “Internet”) 20.

That is, a service, such as a VDSL or an Asymmetric Digital Subscriber Line (ADSL) service, is provided between the DSLAM 15 and the subscriber terminal 12a and between the DSLAM 15 and the telephone 11c through the use of the subscriber line. The DSLAM 15 is separately connected to a PSTN 19 and the PSDN/IP 20, so that the subscriber access network is dualized so as to interface data traffic with the PSDN/IP 20 and POTS traffic with the PSTN 19, respectively, as described above.

Further, as described above, the EPON is constructed so that a plurality of ONTs 17, connected to a subscriber terminal 12b via a splitter, interface with a single OLT 18 located to the PSDN/IP side 20, and are connected to the OLT 18 using optical cables.

As described above, in the prior art, the subscriber access network is separated into several parts according to the types of services to which users subscribe, thus increasing the installation and operation costs of the subscriber access network.

### SUMMARY OF THE INVENTION

Accordingly, the present invention has been made keeping in mind the above problems occurring in the prior art, and an object of the present invention is to provide an Ethernet Passive Optical Network (EPON) system, which integrates the access networks of subscribers subscribing to various services, such as POTS subscribers, TDM subscribers and VDSL subscribers, into a single access network, thus facilitating the installation and operation of the subscriber access network.

In order to accomplish the above object, the present invention provides an Ethernet Passive Optical Network (EPON) system, in which subscriber access networks for at least two of an Ethernet subscriber, a Plan Old Telephone Service (POTS) subscriber, a Very-High-Data-Rate Digital Subscriber Line (VDSL) subscriber and a Time Division Multiplexing (TDM) leased line subscriber are connected to a Packet Switched Data Network (PSDN) and a Packet Switched telephone Network (PSTN), comprising a plurality of optical network terminals each connected to two or more subscriber access networks to perform Ethernet switching for Ethernet frames received from the subscriber access networks and transmit upwardly the Ethernet frames, to convert POTS signals into digital signals and collect a plurality of POTS signals to configure Ethernet frames, and to collect TDM data by a predetermined unit to configure Ethernet frames and transmit upwardly the Ethernet frames, the optical network terminals each separating Ethernet frames received through an optical cable into Ethernet data, POTS data and TDM data, reversely executing the above process, and then transmitting results obtained from the process to a corresponding subscriber access network; an optical line terminal physically connected to an end of the PSDN and a local exchange of the PSTN and adapted to receive Ethernet frames from the optical network terminals, restore POTS signals and TDM data from the Ethernet frames, transmit the POTS signals and the TDM data to the local exchange, and forward Ethernet data to the PSDN, the optical line terminal, in reverse processing, receiving analog signals and data from the PSDN and the local exchange, transmitting Ethernet data of the received signals and data to the optical network terminals without change, collecting POTS signals and TDM data by a predetermined unit to configure Ethernet frames, and transmitting the Ethernet frames to the optical network terminals; and an optical cable connecting the optical line terminal and the plurality of optical network terminals to allow the Ethernet frames to be transmitted therebetween.

Preferably, each of the optical network terminals may comprise an EPON interface unit connected to the EPON to transmit upstream data and receive downstream data; an Ethernet switch connected to the EPON interface unit to switch the upstream data and the downstream data depending on destinations; a VDSL splitter connected to the subscriber access network of the VDSL subscriber to separate VDSL signals and POTS signals, received from the subscriber access network, or multiplex VDSL data and POTS signals of the downstream data received from the Ethernet switch and transmit the multiplexed results to the VDSL subscriber access network; a VDSL interface unit disposed between the VDSL splitter and the Ethernet switch, to convert the VDSL data into Ethernet frames, convert input Ethernet frames into VDSL data, and transmit the Ethernet frames or the VDSL data; and a TDM interface unit collecting POTS signals received from the POTS subscriber access network and the VDSL splitter, and TDM data received from a TDM leased line by a predetermined unit, respectively, converting the collected signals and data into Ethernet frames and transmitting the Ethernet frames to the Ethernet switch, and, in reverse processing, restoring POTS signals and TDM data from data received from the Ethernet switch, respectively, and transmitting the POTS signals and the TDM data to corresponding subscriber access networks.

Preferably, the TDM interface unit may comprise a POTS interface unit interfacing with the POTS subscriber access network to convert POTS signals into digital signals, collect the digital signals by a predetermined unit to configure Ethernet frames, output the Ethernet frames to the Ethernet switch, extract POTS data from input Ethernet frames, convert the POTS data into analog signals, and transmit the analog signals to the POTS subscriber access network; a T1/E1 interface unit interfacing with the TDM leased line T1/E1 to receive and output TDM data; a TDM/Ethernet converting unit collecting POTS data and TDM data received from the POTS interface unit and the T1/E1 interface unit by a predetermined unit, respectively, to configure Ethernet frames, extracting POTS data and TDM data from input Ethernet frames, and outputting the POTS data and TDM data to the POTS interface unit and the T1/E1 interface unit, respectively, the TDM/Ethernet converting unit extracting synchronization information of the local exchange from the Ethernet frames and transmitting the synchronization information to a clock synchronizing unit; and the clock synchronizing unit synchronizing reference clocks of the POTS interface unit and the T1/E1 interface unit with each other in response to the synchronization information received from the TDM/Ethernet converting unit, thus performing signaling and initialization of the optical network terminals.

Preferably, the POTS interface unit may comprise a plurality of overvoltage detection circuits eliminating an overvoltage flowing from a corresponding subscriber line to protect a circuit; a plurality of, subscriber line interface circuits supplying power to a corresponding subscriber line and performing on-hook/off-hook and ring trip detection; a plurality of Coders-Decoders (Codecs) modulating analog signals input from the subscriber line into digital signals, or demodulating input digital signals into analog signals and transmitting the analog signals to the subscriber line; a call signal generator generating a call signal with a frequency of 20 Hz to be transmitted to a normal telephone and transmitting the call signal to the subscriber line; and a PCM/Ethernet converting unit collecting POTS signals digital-modulated by the plurality of Codecs to configure Ethernet frames, extracting modulated POTS signals from input Ethernet frames and transmitting the modulated POTS signals to corresponding Codecs.

Preferably, the clock synchronizing unit may comprise a frequency comparator comparing a local clock of the clock synchronizing unit with the synchronization information of the local exchange extracted by the TDM/Ethernet converting unit; a digital-to-analog converter converting a comparison value output from the frequency comparator into a voltage signal; a Voltage Controlled Crystal Oscillator (VCXO) receiving the voltage signal output from the digital-to-analog converter as a tuning voltage, and oscillating at a frequency corresponding to the tuning voltage; and a Phase Locked Loop (PLL) generating a clock signal phase-matched with the frequency output from the VCXO and applying the clock signal to the POTS interface unit, the T1/E1 interface unit and the frequency comparator.

Preferably, the optical line terminal may comprise an EPON interface unit connected to one or more optical cables to interface with one or more optical network terminals and transmit and receive Ethernet frames to and from the optical network terminals; an Ethernet switch switching Ethernet frames received through the EPON interface unit to the PSDN or PSTN, and switching Ethernet frames received from the PSDN or PSTN to corresponding subscribers; one or more Ethernet interface units connected to the PSDN to interface between the Ethernet switch and the PSDN; and a TDM interface unit disposed between the Ethernet switch or the Ethernet interface units and the local exchange of the PSTN to interface between the Ethernet switch or the Ethernet interface units and the local exchange.

Preferably, the Ethernet switch may allocate a higher priority to TDM traffic than data traffic to perform a switching operation.

Preferably, the Ethernet frames transmitted and received between the optical network terminals and the optical line terminal may be each comprised of an Ethernet Media Access Control (MAC) field indicating an Ethernet MAC address, a synchronization information field loaded with synchronization information of the local exchange of the PSTN, a plurality of channel fields loaded with POTS traffic or TDM data, and a Frame Check Sequence (FCS) field loaded with information for error detection.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a conventional subscriber access network for the Ethernet and PSTN;

FIG. 2 is a view showing the construction of a subscriber access network to which an EPON system of the present invention is applied;

FIGS. 3a and 3b are views showing the format of an Ethernet frame used in the EPON system of the present invention;

FIG. 4 is a block diagram of an optical line terminal provided in the EPON system according to a first embodiment of the present invention;

FIG. 5 is a block diagram of an optical network terminal provided in the EPON system according to the first embodiment of the present invention;

FIG. 6 is a circuit diagram of a clock synchronizing circuit in an optical network terminal provided in the EPON system according to the first embodiment of the present invention;

FIGS. 7a and 7b are flowcharts of a clock synchronizing method performed in the clock synchronizing circuit of FIG. 5;

FIG. 8 is a block diagram showing an example of the construction of an optical network terminal in an EPON system according to a second embodiment of the present invention;

FIG. 9 is a block diagram showing another example of the construction of an optical network terminal in the EPON system according to the second embodiment of the present invention;

FIG. 10 is a block diagram showing the detailed construction of a POTS interface unit provided in the optical network terminal of FIGS. 8 and 9;

FIG. 11 is a view showing the construction of a network to which the EPON system according to the second embodiment of the present invention is applied;

FIG. 12 is a signaling flowchart to set up the connection of a POTS service in the network of FIG. 11;

FIG. 13 is a signaling flowchart to release the connection of the POTS service in the network of FIG. 11;

FIG. 14 is a block diagram showing an example of the construction of an optical network terminal in an EPON system according to a third embodiment of the present invention;

FIG. 15 is a block diagram showing another example of the construction of an optical network terminal in the EPON system according to the third embodiment of the present invention;

FIG. 16 is a block diagram showing a further example of the construction of an optical network terminal in the EPON system according to the third embodiment of the present invention;

FIG. 17 is a block diagram showing an example of the construction of a TDM interface unit of the optical network terminal provided in the EPON system according to the third embodiment of the present invention;

FIG. 18 is a block diagram showing an example of the construction of an optical line terminal in the EPON system according to the third embodiment of the present invention;

FIG. 19 is a block diagram showing another example of the construction of an optical network terminal in the EPON system according to the third embodiment of the present invention;

FIG. 20 is a block diagram showing an example of the construction of a TDM interface unit provided in the optical network terminal in the EPON system according to the third embodiment of the present invention;

FIG. 21 is a flowchart showing an entire operating method performed in the EPON system according to the third embodiment of the present invention; and

FIGS. 22a and 22b are flowcharts showing a TDM data processing method performed in the EPON system according to the third embodiment of the present invention.

### DESCRIPTION OF THE PREFERRED EMBODIMENTS

Hereinafter, the construction and operation of an Ethernet Passive Optical Network (EPON) system according to the present invention will be described in detail with reference to the attached drawings.

FIG. 2 is view schematically showing the construction of an access network for POTS, TDM and VDSL subscribers accommodated in an Ethernet Passive Optical Network system according to the present invention. The subscriber access network is constructed so that, in an EPON comprised of an Optical Line Terminal (OLT) 22 and an Optical Network Terminal (ONT) 21, the ONT 21 interfaces with an Ethernet subscriber, a Plain Old Telephone Service (POTS) subscriber, a VDSL subscriber and a TDM leased line subscriber to communicate with the OLT 22, and the OLT 22 interfaces with a plurality of ONTs 21 to interface IP traffic with a PSDN/IP network 25 and to interface TDM traffic and POTS traffic with a PSTN 24.

The OLT 22 has a physical interface, such as an E1/T1 interface and a Synchronous Transport Module (STM)-1 interface, with a local exchange 23 of the PSTN 24, and has a V5.2 interface for signaling and link management.

In the above-described EPON, a clock used in the EPON must be synchronized with that of the local exchange 23 so as to be synchronized with the local exchange 23. Further, since an Ethernet clock should be synchronized with the clock of the local exchange 23 when the Ethernet, not the EPON, is used, the EPON clock is not synchronized, but the clocks of the local exchange 23 and the TDM interface of the ONT 21 are synchronized with each other, thus enabling the TDM network to be synchronized with the local exchange 23. The TDM interface of the OLT 22 recovers the clock of the local exchange 23, loads synchronization information on TDM frames and transmits the TDM frames to the ONT 21. The ONT 21, having received this synchronization information, compares the information with the local clock of the ONT 21 and then synchronizes the local clock with the clock of the local exchange 23.

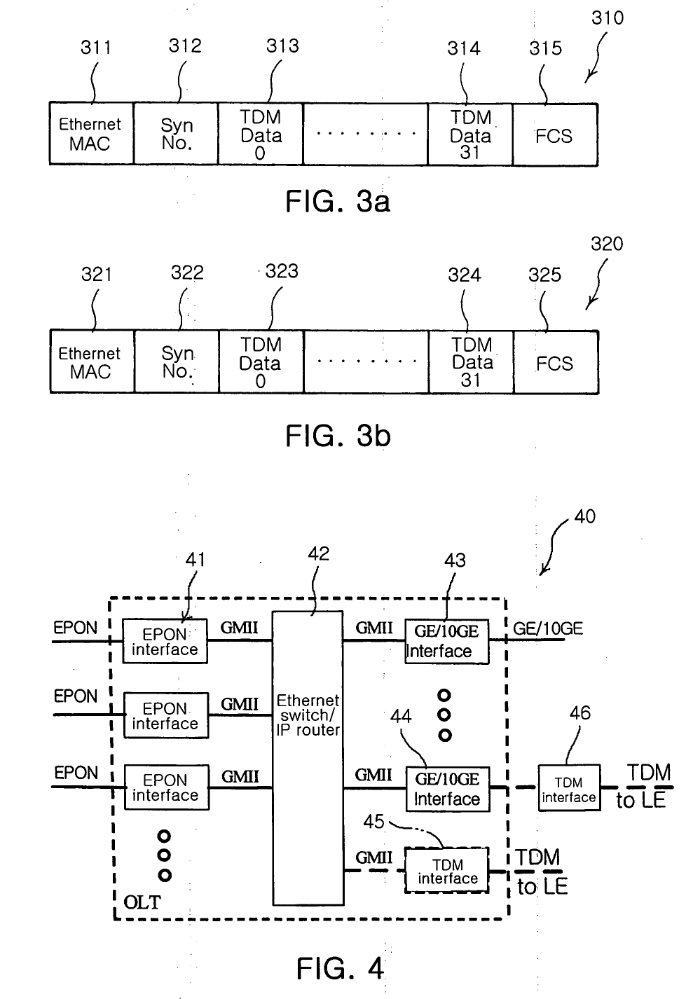

FIGS. 3a and 3b are views showing the configuration of an Ethernet frame exchanged in the EPON system of the present invention of FIG. 2.

First, FIG. 3a is a configuration view of an Ethernet frame 310 to accommodate a TDM frame, in which the Ethernet frame 310 is comprised of an Ethernet MAC field 311, a synchronization number field 312, TDM data fields 313 and 314, and a Frame Check Sequence (FCS) field 315. The Ethernet Mac field 311 is used to allow the addresses of respective terminals of the Ethernet to be recorded therein, the synchronization number field 312 is used to allow information for synchronizing a clock to be recorded therein, the TDM data fields 313 and 314 are used to allow TDM frames received through the TDM leased line to be recorded therein, and the FCS field 315 is used to detect any transmission error of data.

The configuration of the Ethernet frame shown in FIG. 3a can be modified to various formats, and needs to satisfy the condition that TDM frames are transmitted so as not to change the sequence of the time slots 313 and 314 of each of accommodated TDM frames.

Further, FIG. 3b is a view showing the configuration of an Ethernet frame to accommodate a POTS signal for a VDSL subscriber or a POTS subscriber in the EPON of the present invention. Similar to the configuration of FIG. 3a, the Ethernet frame is comprised of an Ethernet MAC field 321, a synchronization number field 322, a plurality of channel fields 323 and 324, and a FCS field 325.

The Ethernet MAC field 321 is used to allow the addresses of respective terminals of the Ethernet to be recorded therein, the synchronization number field 322 is used to allow information for synchronizing a clock to be recorded therein, and the FCS field 325 is used to detect the transmission error of data. Moreover, the plurality of channel fields 323 and 324 are distinguished by time slots and then allocated to respective POTS subscribers. At this time, POTS signals according to respective subscribers maintain the allocated time slots, thus maintaining virtual lines between POTS subscriber terminals.

The ONT 21 and the OLT 22 may have various constructions depending on the types of services to be accommodated.

FIG. 4 is a block diagram showing the detailed construction of an OLT according to a first embodiment of the present invention, which accommodates TDM subscribers and VDSL subscribers.

The OLT 40 of FIG. 4 includes a plurality of EPON interface modules 41 to interface with a plurality of ONTs 21, an Ethernet switch (or IP router) 42 to switch Ethernet frames or IP packets, Ethernet interface units 43 and 44 to perform Ethernet interface with the PSDN/IP 25, and a TDM interface unit 45 to interface with a local exchange 23. Further, the OLT 40 includes an external TDM interface unit 46 connected to the Ethernet interface unit 44, thus realizing interface with the local exchange 23.

The TDM interface units 45 and 46 perform TDM interface with the local exchange 23 provided at the end of the PSTN 24 and Ethernet interface with the Ethernet switch 42. For this operation, the TDM interface units 45 and 46 perform an Ethernet/TDM data conversion function and an International Telecommunications Union-Telecommunication Standardization Sector (ITU-T) Recommendations G. 965 V5.2 interface function for signaling and link management, and further performs a function of recovering the clock of the local exchange 23 from a link connected to the local exchange 23, utilizing the recovered clock and providing clock information to the ONT 21.

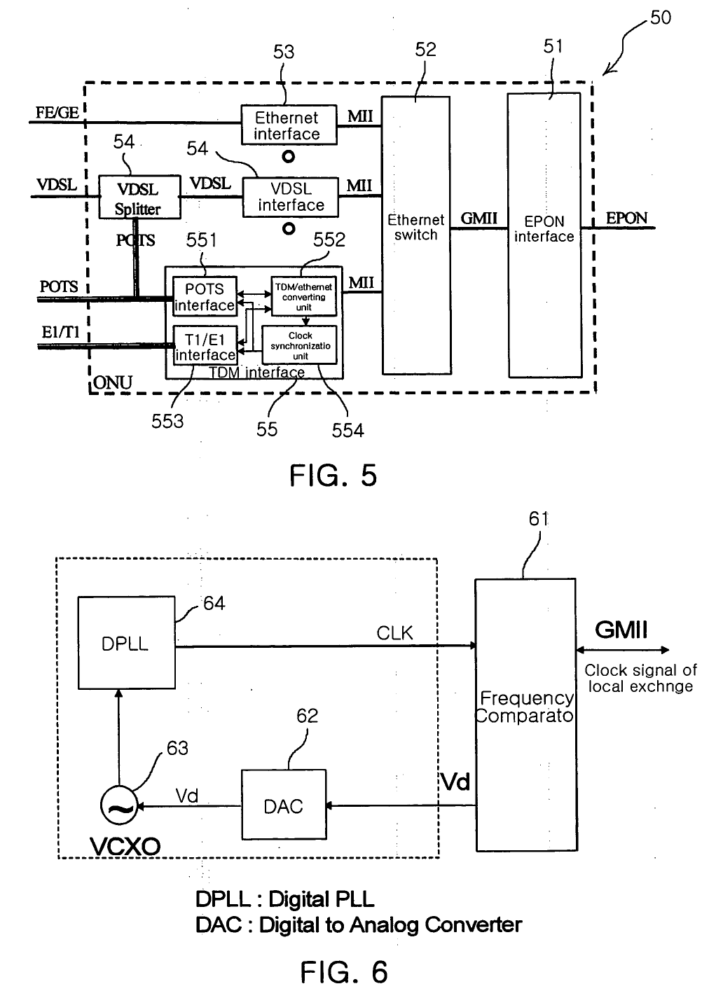

Next, FIG. 5 is a view showing the construction of an ONT according to a second embodiment of the present invention, which accommodates TDM and VDSL service subscribers.

An ONT 50 includes an EPON interface unit 51 to perform EPON interface with the OLT 21, Dan Ethernet switch 52 to switch Ethernet frames transmitted through the EPON interface unit 51, a plurality of Ethernet interface units 53 to perform Ethernet interface with the Ethernet switch 52, a VDSL splitter 54 to separate VDSL data signals for VDSL subscribers from POTS signals or combine the VDSL data signals with the POTS signals, a plurality of VDSL interface units 56 to interface VDSL data signals, separated by the VDSL splitter 54, with the Ethernet switch 52, and a TDM interface unit 55 to interface the POTS signals for POTS subscribers and VDSL subscribers, separated by the VDSL splitter 54, with the Ethernet switch 52 and interface TDM signals for TDM leased line subscribers, such as E1/T1 signals, with the Ethernet switch 52.

The interface with the Ethernet switch 52 varies depending on an accommodated data rate. For example, Media Independent Interface (MII) is used when a data rate is 100 Mbps, Gigabit Media Independent Interface (GMII) is used when a data rate is 1 Gbps, and 10 Gigabit Media Independent Interface (XGMII) is used when a data rate is 10 Gbps. The TDM interface unit 55 is connected to the Ethernet switch 52 using the MII, and communicates with the Ethernet switch 52 using Ethernet frames having the configuration of FIG. 3a.

The TDM interface unit 55 is constructed to include a POTS interface unit 551, a TDM/Ethernet converting unit 552, a T1/E1 interface unit 553 and a clock synchronizing unit 554.

The POTS interface unit 551 accommodates normal subscribers and POTS subscribers of the VDSL, and performs Battery feed, Overvoltage protection, Ringing, Supervision, Code/decode, Hybrid and Test: BORSCHT) functions to realize the accommodation. If the function of the POTS interface unit 551 is described in the signal transmission aspect, analog POTS signals received from a subscriber line are encoded into Pulse Code Modulation (PCM)-type digital signals, the encoded PCM signals are collected and converted into packets in the form of Ethernet frames, and then the Ethernet frames are output. The Ethernet frames from the POTS interface unit 551 are transmitted to the TDM interface units 45 and 46 of the OLT 40 of FIG. 4 through the Ethernet switch 52 and the EPON interface unit 51 after passing through the TDM/Ethernet converting unit 552. The Ethernet frames generated by the POTS interface unit 551 have the configuration of FIG. 3b, and are configured by collecting data from a plurality of POTS differently from Voice over Internet Protocol (VoIP), thus increasing packet efficiency and reducing delays. In contrast, Ethernet frames received from the TDM interface units 45 and 46 of the OLT 40 are transmitted to the TDM interface unit 55 through the EPON interface unit 51 and the Ethernet switch 52. From the Ethernet frames, PCM data are extracted by the POTS interface unit 551 of the TDM interface unit 55 and decoded into analog signals, and the analog signals are transmitted to the subscriber line.

Further, the TDM/Ethernet converting unit 552 converts TDM data into Ethernet frames or extracts TDM data from Ethernet frames between the T1/E1 interface unit 553 and the Ethernet switch 52. The T1/E1 interface unit 553 collects TDM signals received from the T1/E1 leased line of the TDM subscribers in frames of 125 us to configure Ethernet frames, and transmits the Ethernet frames to the TDM interface units 45 and 46 of the OLT 40 of FIG. 4. In the reverse processing, the T1/E1 interface unit 553 extracts TDM data from the Ethernet frames received from the OLT 40, loads the TDM data on a corresponding channel of the TDM leased line, and then transmits the TDM data. The TDM interface unit 55 transparently transmits the TDM data of the E1/T1 line to the local exchange through the OLT 40.

The clock synchronizing unit 554 performs the functions, such as on-hook, off-hook, ringing and ring trip detection through the POTS interface unit 551, and the functions, such as signaling with the OLT 40 and the initialization and maintenance of the TDM interface unit 55. Especially, the clock synchronizing unit 554 extracts clock information from synchronization number fields 312 and 322 of the Ethernet frames received from the OLT 40, compares the clock information with the clock of the clock synchronizing unit 554 (that is, a local clock), synchronizes the local clock of the clock synchronizing unit 554 with the clock of the local exchange 23, and provides the clock synchronized through the above procedure to the POTS interface unit 551 and the T1/E1 interface unit 553. The POTS interface unit 551 samples signals and transmits data using the clock, synchronized with the local exchange 23 and received from the clock synchronizing unit 554. The T1/E1 interface unit 553 transmits data using the clock synchronized with the local exchange 23.

FIG. 6 is a view showing a synchronizing circuit of the clock synchronizing unit 554 provided in the ONT 50. The synchronizing circuit includes a frequency comparator 61 to compare the local clock of the clock synchronizing unit 554 with the clock of the Local Exchange (LE), extracted from received Ethernet frames, a Digital-to-Analog converter (DAC) 62 to convert digital comparison data output from the frequency comparator 61 into an analog signal Vd, a Voltage Controlled Crystal Oscillator (VCXO) 63 to receive the analog signal output from the DAC 62 as a tuning voltage and generate a frequency signal corresponding to the tuning voltage, and a Digital Phase Locked Loop (DPLL) 64 to match the phase of the frequency signal oscillated by the VCXO 63 and output the phase-matched signal.

In the above construction, the frequency comparator 61 outputs a frequency difference between the clock output from the DPLL 64 and the clock, extracted from the clock information of the Ethernet frames transmitted from the OLT 40, and transmits data corresponding to the frequency difference to the DAC 62. The DAC 62 converts input data into the analog voltage signal Vd, and applies the analog voltage signal Vd to the tuning voltage terminal of the VCXO 63. Therefore, the VCXO 63 generates a clock with a frequency corresponding to the applied tuning voltage. The DPLL 64 matches the phase of the clock, applies the phase-matched clock to the frequency comparator 61, and also applies the phase-matched clock to both the POTS interface unit 551 and the T1/E1 interface unit 553 as clock signals. At this time, the VCXO 63 must satisfy clock stability and variable ranges required by the T1/E1 interface.

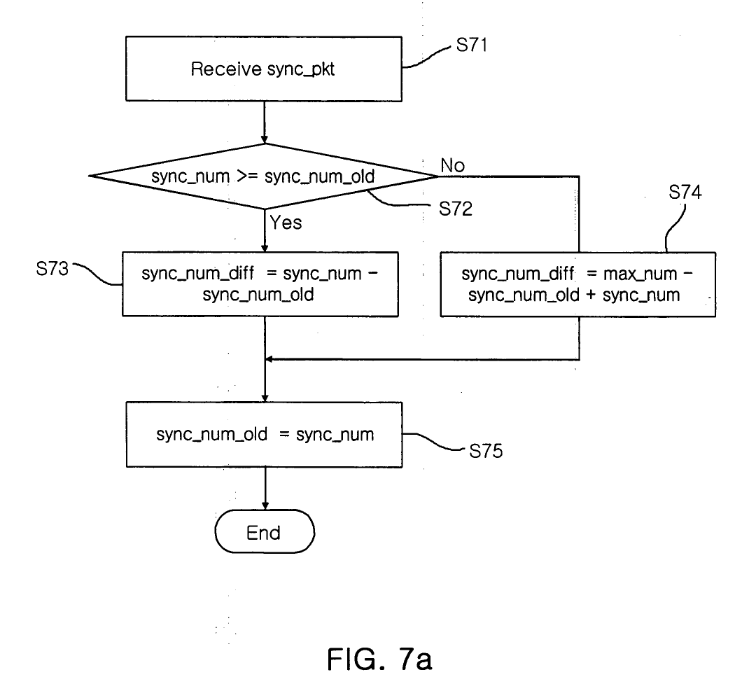

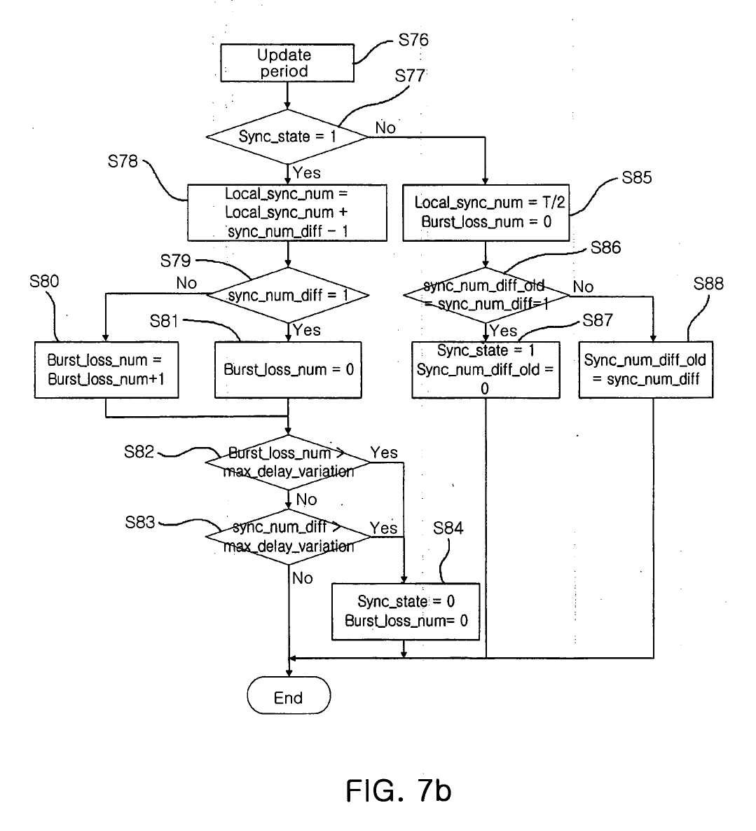

FIGS. 7a and 7b are flowcharts showing a clock synchronizing process executed by the TDM interface unit 55. The clock synchronizing process is described in detail with reference to FIGS. 7a and 7b.

First, if an Ethernet frame is received from the OLT 40 connected to the PSDN/IP network 25, the TDM interface unit 55 separates a synchronization packet sync_pkt from the received Ethernet frame, and extracts synchronization information sync_num from the synchronization packet sync_pkt at step S71.

The synchronization information sync_num is a series of numbers increasing from “0” to a maximum value Max_num by “1”, which restarts from “0” if the increased number has reached the maximum number Max_num.

Further, the TDM interface unit 55 compares the extracted synchronization information sync_num with synchronization information sync_num_old, obtained from a previous period, and then determines whether current synchronization information sync_num is equal to or greater than the previous synchronization information sync_num_old at step S72.

If the current synchronization information sync_num is equal to or greater than the previous synchronization information sync_num_old, the TDM interface unit 55 calculates “sync_num−sync_num_old” as a synchronization information difference sync_num_diff at step S73. In contrast, if the current synchronization information sync_num is less than the previous synchronization information sync_num_old, the TDM interface unit 55 calculates “Max_num+sync_num−sync_num_old” as a synchronization information difference sync_num_diff at step S74. The above process is executed to prevent the synchronization information difference sync_num_diff from having a negative value when the previous synchronization information sync_num_old is a maximum value Max_num and the current synchronization information sync_num is “0”, depending on the characteristics of the synchronization information sync_num, which is repeatedly increased by “1” between “0” and the maximum value Max_num.

If the synchronization information difference sync_num_diff is obtained as described above, the current synchronization information sync_num is changed to previous synchronization information sync_num_old so as to process synchronization information to be received later at step S75.

The above-described synchronization information reception process is repeatedly executed whenever synchronization information is received from the OLT 40 connected to the PSDN/IP network 25.

Further, a process of synchronizing the reference clock of the OLT 40 with the clock of the local exchange at update periods, preset on the basis of both synchronization information sync_num and the synchronization information difference sync_num_diff obtained through the above process, is executed as shown in FIG. 7b, which is described in detail. In this case, the update periods are equal to periods at which a synchronization packet is generated in the OLT 40. Actually, when the two clocks are synchronized with each other, the update periods become equal to the generation periods of the synchronization packet.

As shown in FIG. 7b, if a current time has reached the update period at step S76, the TDM interface unit 55 examines a state information value sync_state indicating whether the two clocks are synchronized at step S77. The state information sync_state is a state value indicating whether the clock of the ONT 50 is synchronized with the clock of the local exchange. That is, state information “1” represents a synchronous state, while state information “0” represents an asynchronous state.

As a result, if the state information sync_state is “0”, that is, representing an asynchronous state, the clock information of the ONT 50 itself local_sync_num is set to an intermediate value T/2 of the input range of the DAC 62 so as to control the output of the VCXO 63 to be at a center frequency, and non-updated period information burst_loss_num is initialized to “0” at step S85. Thereafter, it is determined whether previous and current synchronization information difference values sync_num_diff_old and sync_num_diff are “1”, respectively, at step S86. That the respective synchronization information difference values sync_num_diff_old and sync_num_diff are “1” means that precise synchronization information sync_num has been received at two consecutive update periods. Therefore, if at least one of the previous and current synchronization information difference values sync_num_diff_old and sync_num_diff is not “1”, the TDM interface unit 55 changes the current synchronization information difference value sync_num_diff to the previous synchronization information difference value sync_num_diff_old, and then stands by until a next update period at step S88. If both the previous and current synchronization information difference values sync_num_diff_old and sync_num_diff are “1”, the TDM interface unit 55 sets a synchronous state sync_state to “1”, changes the previous synchronization information difference value sync_num_diff_old to “0”, and then stands by until a next update period at step S87.

In contrast, if the synchronous state sync_state is “1”, the TDM interface unit 55 sets the synchronization information of the ONT 50 itself local_sync_num to “local_sync_num+sync_num_diff−1” at step S78. Thereafter, it is determined whether the synchronization information difference sync_num_diff is 0 or 1, that is, whether the clock of the ONT 50 is synchronized with the clock of the local exchange. If the clock of the ONT 50 is synchronized with the clock of the local exchange, that is, sync_num_diff=0, the TDM interface unit 55 sets the burst_loss_num to “0”, while if the clock of the ONT 50 is not synchronized with the clock of the local exchange, that is, sync_num_diff=1, the TDM interface unit 55 increases the burst_loss_num by “1” at steps S80 and S81.

Further, it is determined whether the burst_loss_num or the synchronization information difference sync_num_diff exceeds a preset maximum allowable value max_delay_variation at steps S82 and S83. If the burst_loss_num or the synchronization information difference sync_num_diff exceeds the preset maximum allowable value max_delay_variation, the TDM interface unit 55 determines that a current state is an asynchronous state, changes the synchronous state information sync_state to “0”, and initializes the burst_loss_num to “0” at step S84. In this case, that the burst_loss_num or the sync_num_diff exceeds the preset maximum allowable value max_delay_variation means that packets are not satisfactorily received during a preset allowable period or the synchronization information difference deviates from an allowable range.

The above-described update procedure is periodically repeated, so that the voltage Vd corresponding to the synchronization information of the ONT 50 itself local_sync_num, preset by the update procedure, is output from the DAC 62 and applied to the VCXO 63 as a tuning voltage. Therefore, the VCXO 63 outputs a clock signal corresponding to the tuning voltage through the DPLL 64 that generates a frequency signal synchronized with the local exchange (LE). Therefore, the ONT 50 can be operated in synchronization with the local exchange (LE).

Next, a second embodiment of the present invention is described, in which the EPON system of the present invention accommodates only VDSL subscribers and POTS subscribers.

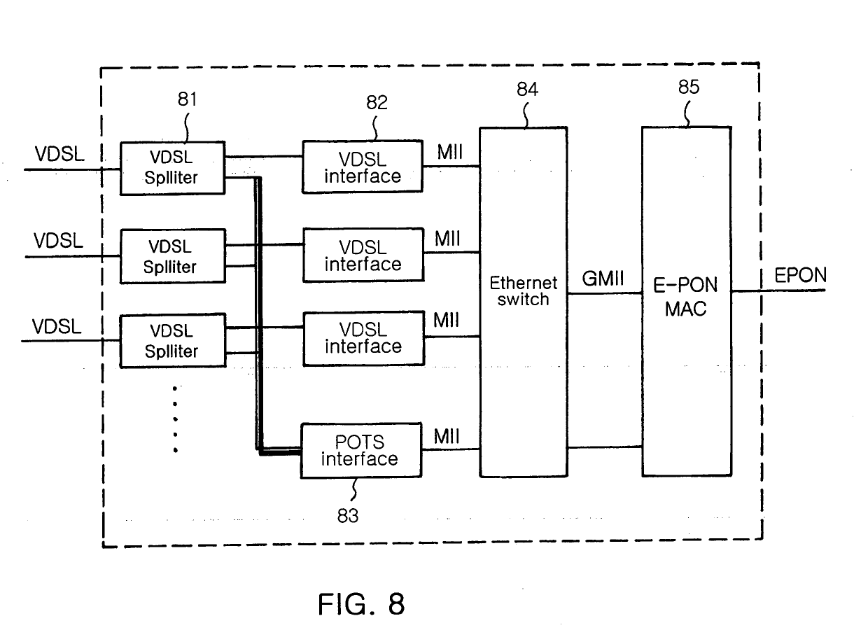

FIG. 8 is a block diagram showing the construction of the ONT of an EPON according to a second embodiment of the present invention. The ONT includes one or more VDSL splitters 81, one or more VDS interface units 82, a POTS interface unit 83, an Ethernet switch 84 and an EPON interface unit 85. The VDSL splitters 81 are connected to VDSL subscriber lines, respectively, to separate transmission signals, input from VDSL subscribers, into data traffic and POTS signals, and, in the reverse processing, to transmit input data traffic and POTS signals to corresponding VDSL subscriber lines through different bands. The VDSL interface units 82 demodulate respective VDSL data signals output from the VSDL splitters 81 and transmit the demodulated data signals to the Ethernet switch 84. In the reverse processing, the VDSL interface units 82 modulate data transmitted from the Ethernet switch 84 into VDSL signals and transmit the VDSL signals to corresponding VDSL splitters 81. The POTS interface unit 83 collects the POTS signals separated by the VDSL splitters 81, performs Pulse Code Modulation (PCM) with respect to the POTS signals to configure Ethernet frames and transmits the Ethernet frames to the Ethernet switch 84. In the reverse processing, the POTS interface unit 83 demodulates PCM signals according to respective channels from Ethernet frames input from the Ethernet switch 84 and transmits the PCM signals to corresponding VDSL splitters 81. The Ethernet switch 84 switches the plurality of VDSL interface units 82 and the POTS interface unit 83 depending on the MAC address and Virtual Local Area Network (VLAN) address of the Ethernet, and transmits received data to the EPON interface unit 85 through Gigabit Media Independent Interface (GMII). In the reverse processing, the Ethernet switch 84 transmits signals, input from the EPON interface unit 85, to a VDSL interface unit 82 and a POTS interface unit 83 of a corresponding route. The EPON interface unit 85 transmits upstream data transmitted from the Ethernet switch 84 to the EPON at allocated times in view of priority, and transmits received downstream data to a VDSL interface unit 82 and a POTS interface unit 83 of a corresponding route through the Ethernet switch 84 depending on MAC addresses.

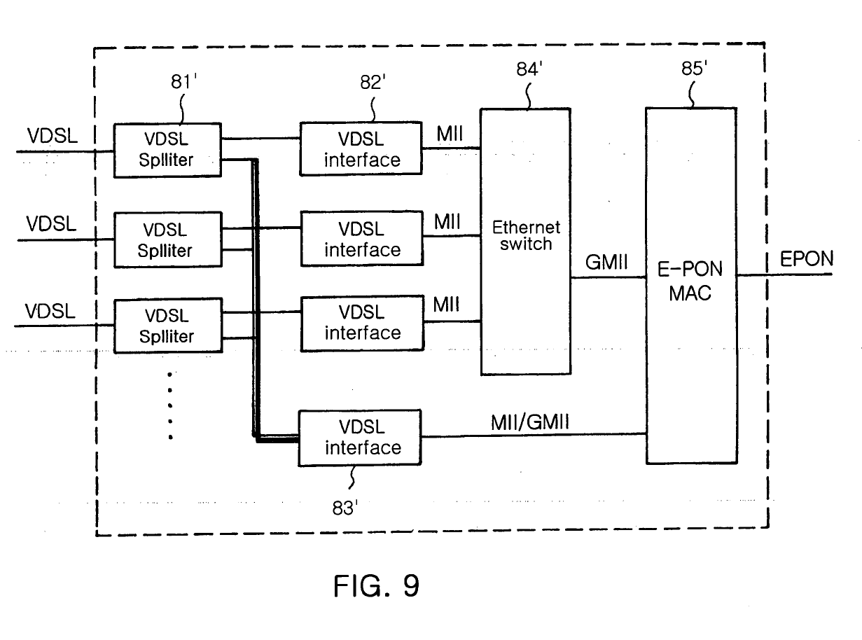

FIG. 9 is a view showing another example of the construction of an ONT in the EPON system according to the second embodiment of the present invention. Similar to FIG. 8, the ONT includes one or more VDSL slitters 81′, one or more VDSL interface units 82′, a POTS interface unit 83′, an Ethernet switch 84′, and an EPON interface unit 85′, and performs the same functions as those of FIG. 8. At this time, the POTS interface unit 83′ is directly connected to the EPON interface unit 85′ without passing through the Ethernet switch 84′, in which a dedicated bandwidth for POTS signals is allocated and the delays and delay variations of the POTS signals caused by data traffic are minimized.

That is, Ethernet frames loaded with POTS signals, output from the POTS interface unit 83′, are directly transmitted to the EPON interface unit 85′ using a dedicated bandwidth. Further, Ethernet frames in a band loaded with POTS signals transmitted from the EPON are directly transmitted to the POTS interface unit 83′, without priorities between the Ethernet frames and data traffic being considered.

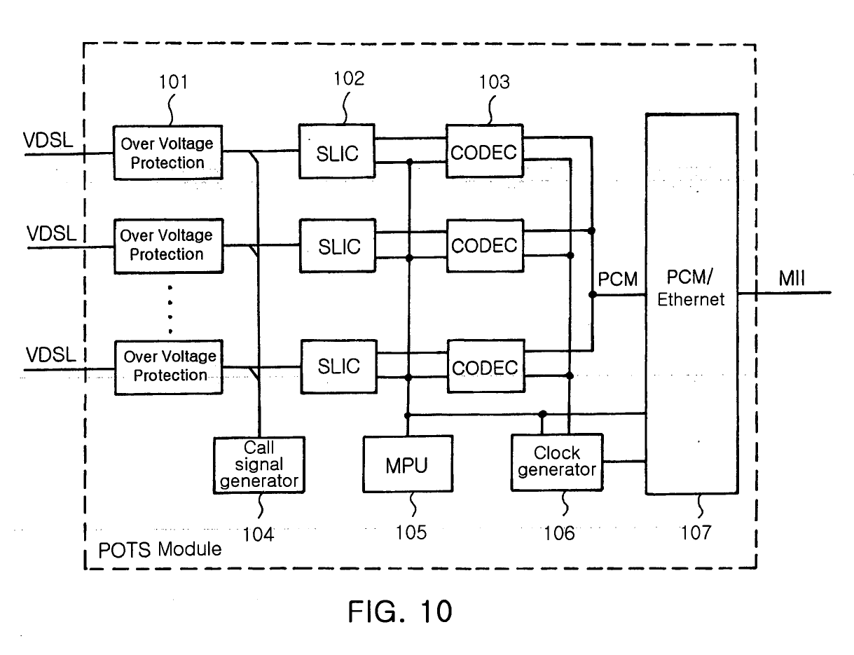

FIG. 10 is a view showing the detailed construction of the POTS interface units 83 and 83′ of FIGS. 8 and 9 in the second embodiment of the present invention. As shown in FIG. 10, the POTS interface unit 83 or 83′ includes a plurality of overvoltage protection circuits 101, a plurality of subscriber line interface circuits 102, a plurality of Coders-Decoders (Codecs) 103, a call signal generator 104, a Micro-Processing Unit (MPU) 105, a clock generator 106 and a PCM/Ethernet converting unit 107. The overvoltage protection circuits 101 are connected to VDSL subscriber lines through the VDSL splitter 81 or 81′ to eliminate an overvoltage flowing from the subscriber lines and protect a circuit. The subscriber line interface circuits 102 are connected to the overvoltage protection circuits 101, respectively, to perform the supply of power, on-hook/off-hook and ring trip detection. The Codecs 103 modulate analog signals input from the VDSL subscriber lines into PCM signals, and demodulate PCM signals (for example, at 64 kbps recommended by ITU-T G.711) into analog signals. The call signal generator 104 generates a call signal with a frequency of 20 Hz required to call a subscriber under the control of the MPU 105 and provides the call signal to the subscriber. The MPU 105 initializes the POTS interface unit, detects on-hook/off-hook, controls a ring relay to provide the call signal, controls the generation and stopping of signaling, and manages MAC and IP addresses. The clock generator 106 generates and provides a clock synchronized with the local exchange 23 in response to synchronization packets periodically received from the OLT 22. The PCM/Ethernet converting unit 107 collects modulated PCM signals, output from the plurality of Codecs 103, to configure Ethernet frames and outputs the Ethernet frames to the Ethernet switch 84 or the EPON interface unit 85′ through Medium Independent Interface (MII), loads PCM signals, included in the received Ethernet frames, into a corresponding time slot and transmits the PCM signals to a corresponding Codec 103.

In the construction, each PCM signal modulated by the Codecs 103 has a plurality of time slots, for example, 32 time slots, so that a unique time slot is allocated to each of VDSL subscribers, thus enabling a corresponding VDSL subscriber signal to be transmitted through the allocated time slot. Further, the clock generator 106, adapted to generate a reference clock signal for synchronization with the local exchange 23, extracts synchronization information from Ethernet frames received from the OLT 22, compares the synchronization information with the generated clock, and generates the reference clock signal synchronized with the clock of the local exchange 23 through a PLL. This clock generator 106 can be implemented with the synchronization circuit and method of FIG. 6 and FIGS. 7a and 7b.

The subscriber line interface circuits 102, the Codecs 103 and the PCM/Ethernet converting unit 107 are operated in synchronization with the reference clock signal generated by the clock generator 106. Further, the MPU 105 performs a control function for the initialization and operation of the apparatus, and manages MAC or IP addresses. Further, if IP addresses are used, the MPU 105 provides an “Address Resolution Protocol (ARP) reply” function.

The number of POTS modules mounted in the ONT having the above construction can be arbitrarily designated, and the configuration of data loaded on Ethernet frames can be programmably changed.

In the ONT having the above construction, data from a VDSL terminal, of signals input through VDSL subscriber lines, are input to a corresponding VDSL splitter 81 or 81′, separated from POTS signals, demodulated by the VDSL interface unit 82 or 82′ and then transmitted to the Ethernet switch 84 or 84′ through Media Independent Interface (MII). The Ethernet switch 84 or 84′ switches the VDSL data, input through GMII, depending on MAC and VLAN addresses, thus transmitting the VDSL data to the EPON interface unit 85 or 85′. The EPON interface unit 85 or 85′ upwardly transmits the received VDSL data to the OLT 22 in a time slot allocated thereto in the EPON in view of priority.

In contrast, VDSL data transmitted from the OLT 22 are received by the EPON interface unit 85 or 85′, transmitted to the Ethernet switch 84 or 84′ through GMII, and then transmitted to the corresponding. VDSL interface unit 82 depending on a MAC address. Thereafter, the transmitted data are modulated into VDSL data by the VDSL interface unit 82, and the VDSL data are transmitted to a VDSL subscriber line through the VDSL splitter 81 or 81′ and applied to the VDSL terminal 12a located at the end of the VDSL subscriber line.

On the other hand, the POTS signals include various signals, such as a Dual Tone Multi-Frequency (DTMF) signal, a call signal, a dial tone and a ringback tone, as well as actual voice signals, so that a signaling process for the signals is required.

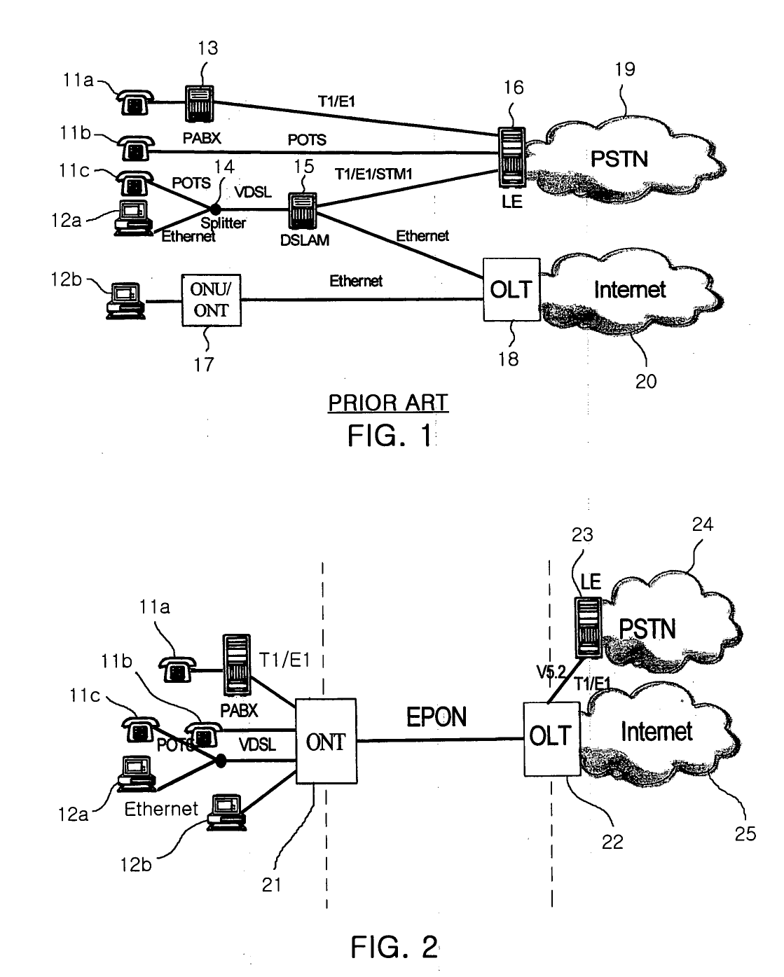

The normal telephone 11b of FIG. 1 is connected to the ONT 21 through a VDSL subscriber line, and signals output from the normal telephone 11b are separated by the VDSL splitter 81 in the ONT 21 and input to the POTS interface unit 83 or 83′. The POTS interface unit 83 or 83′ examines the signals output from the normal telephone 11b to enable a POTS service to be provided in the EPON.

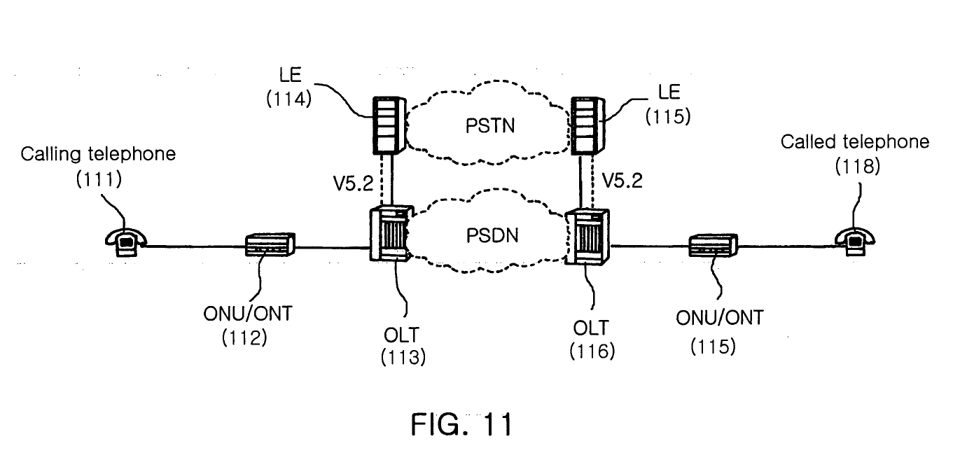

This POTS signal processing is described in detail with reference to FIGS. 11 to 13.

FIG. 11 is a view showing the construction of a network system in which two POTS subscribers are connected to each other over the EPON of the present invention. In FIG. 11, ONTs 112 and 115 are constructed as shown in FIGS. 8, 9 and 10.

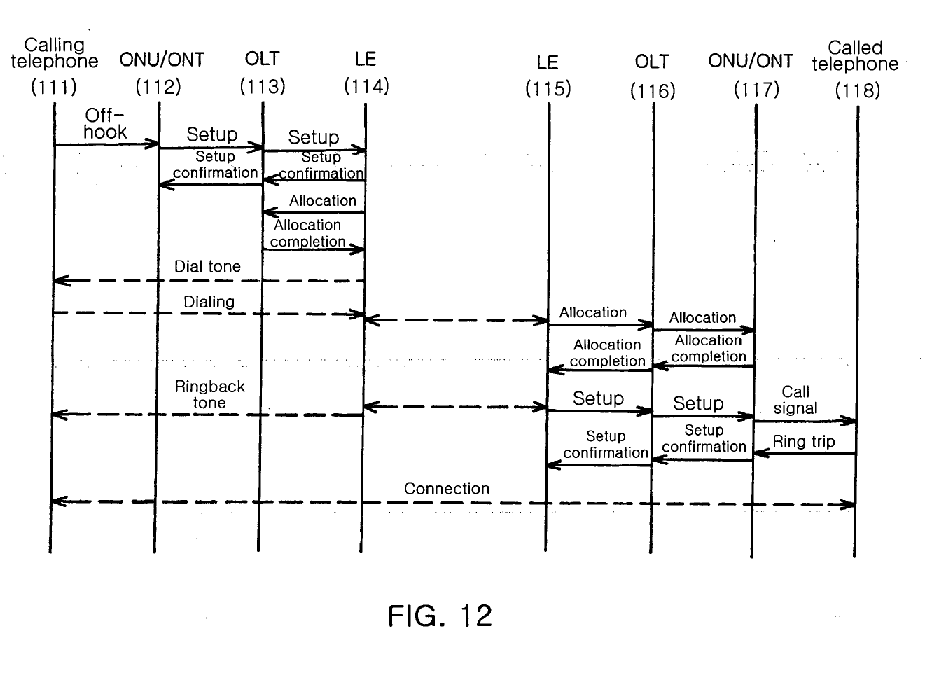

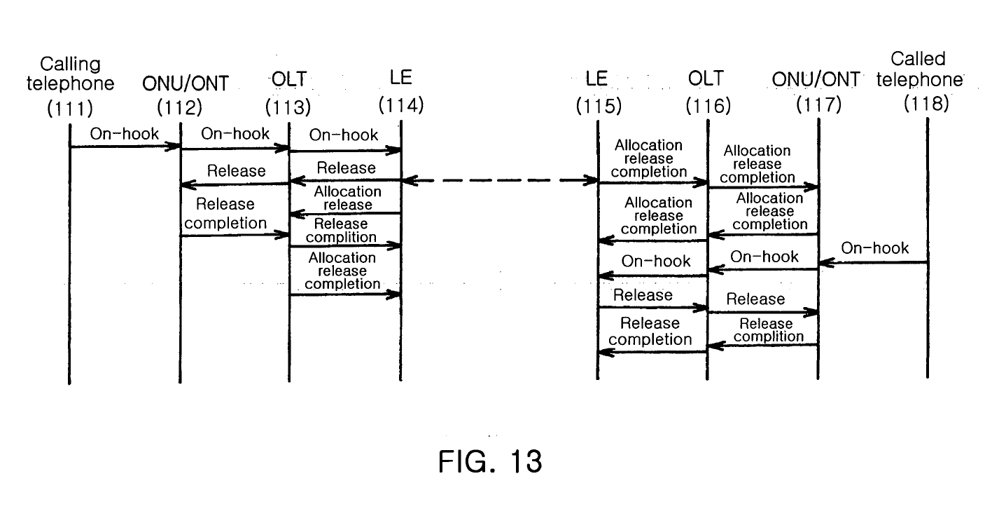

Further, FIGS. 12 and 13 are views showing signaling processes between a calling telephone 111 and a called telephone 118 of FIG. 11.

According to POTS service procedures, if a POTS subscriber picks up the receiver of the calling telephone 111, the calling telephone 111 is switched from an on-hook state to an off-hook state. The POTS interface unit 83 or 83′ of the ONT 112 examines POTS band signals from a VDSL subscriber line and then determines whether the calling telephone 111 is in an off-hook or on-hook state.

Therefore, if the calling telephone 111 transmits an off-hook signal, the subscriber line interface circuit 102 of the POTS interface unit 83 or 83′ detects the off-hook signal, and the MPU 105 outputs a connection setup signal based on the off-hook signal. The connection setup signal is transmitted to an originating local exchange 114 through the Ethernet switch 84, the EPON interface unit 85 or 85′, and a higher OLT 113.

Therefore, the originating local exchange 114 recognizes that the calling terminal 111 is in the off-hook state, and transmits a setup confirmation message to the corresponding ONT 112 through the OLT 113 as a confirmation message to the off-hook signal.

The POTS interface unit 83 or 83′ of the ONT 112 receives the setup confirmation message and then confirms that the originating local exchange 114 has received the connection setup signal. If the setup confirmation signal is not received, the POTS interface unit 83 or 83′ re-transmits the connection setup signal.

Further, the originating local exchange 114, having received the connection setup signal, transmits a channel allocation message to the OLT 113. The OLT 113 receives the channel allocation message to allocate a corresponding channel for POTS services, and sends an allocation completion message to the local exchange 114.

Therefore, the local exchange 114 transmits a dial tone through the allocated channel, which is transmitted to the calling telephone 111 through the OLT 113 and the ONT 112. Accordingly, the calling subscriber confirms the dial tone through the receiver of the calling telephone 111, and then dials a destination phone number, that is, a called subscriber number.

The phone number of the calling telephone 111 is transmitted to the ONT 112 along the VDSL subscriber line in the form of a DTMF signal, and converted into PCM signals by the POTS interface unit 83 or 83′ of the ONT 112. The PCM signals are loaded on an allocated channel for Ethernet frames, transmitted to the higher OLT 113, and then transferred to the originating local exchange 114.

Thereafter, the originating local exchange 114 analyzes the received DTMF signal, and then signalizes a destination local exchange 115 using an inter-exchange signaling method.

Therefore, at a called side, a channel allocation to an OLT 116 and an ONT 117 from the local exchange 115 is performed. After the channel allocation has been completed, an allocation completion signal is transmitted to the local exchange 115. As described above, after the channel allocation has been completed at the called side, a setup message is transmitted from the destination local exchange 115 to the ONT 117 through the destination OLT 116. The POTS interface unit 83 or 83′ of the ONT 117 transmits a call signal to the called telephone 118 in response to the setup message, transmitted as described above.

Through the above process, a ringing tone is generated at the called telephone 118, and a ring trip occurs when the called subscriber picks up the receiver of the called telephone 118. The POTS interface unit 83 or 83′ of the destination ONT 117 detects the ring trip, and then transmits a setup confirmation message to the destination local exchange 115 through the OLT 116. Accordingly, a connection between the calling and called telephones 111 and 118 over the EPON has been established.

Thereafter, voice signals between the calling and called telephones 111 and 118 are modulated into digital signals (PCM signals) by the ONTs 112 and 117 connected thereto, respectively, and the digital signals are loaded on Ethernet frames and transmitted to opposite parties through a channel established between the telephones 111 and 118. Received voice data are demodulated into original analog signals by the ONTs 112 and 117 and transmitted to opposite telephones 111 and 118 through a VDSL subscriber line. Therefore, a voice communication is performed through the calling and called telephones 111 and 118.

In contrast, when the communication has terminated, on-hook is detected at the side where a subscriber hangs up the receiver first, and then connection release signaling is performed. FIG. 13 shows a case where connection release begins at the calling telephone 111.

That is, when the receiver of the calling telephone 111 is hung up and an on-hook state is detected, the detected on-hook signal is transmitted to a corresponding local exchange 114 through the OLT 113 by the operations of the POTS interface unit 83 or 83′ and the ONT 112. The local exchange 114, having received the on-hook signal, transmits a connection release signal to the ONT 112 through the OLT 113. Through the above process, when the connection to the local exchange 114 is released, a release completion signal is transmitted to the local exchange 114 through the OLT 113. Further, the local exchange 114 transmits a signal requesting the release of a channel allocation to the OLT 113. Therefore, the channel allocated for the calling telephone 111 is released.

Further, the local exchange 114 transmits a connection release signal to the local exchange 115 to which the opposite telephone belongs, and the local exchange 115 of the opposite telephone transmits an allocation release signal to the ONT 117 through the corresponding OLT 116. Therefore, the ONT 117 releases the channel allocation and, in the reverse processing, transmits an allocation release completion signal to the local exchange 115 through the OLT 116.

Therefore, when the receiver of the called telephone 118 is hung up and an on-hook signal is generated, the on-hook signal is transmitted to the local exchange 115 through the OLT 116 by the ONT 117. The connection release signal is applied by the local exchange 115 to a lower OLT 116 and ONT 117, so that the connection between the local exchange 115 and the ONT 117 is released. Thereafter, a release completion signal is transmitted to the local exchange 115, thus releasing the connection between normal telephones 111 and 118.

Next, a third embodiment of the present invention, which accommodates a TDM leased line, is described.

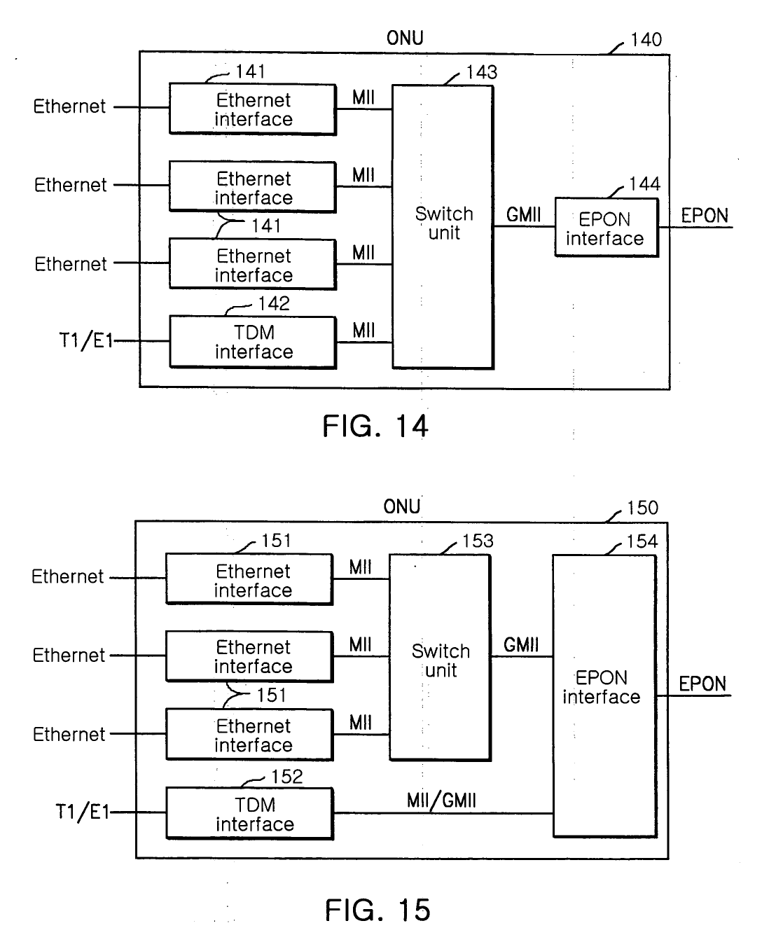

FIG. 14 is a block diagram of an ONT accommodating a TDM leased line according to a third embodiment of the present invention.

Referring to FIG. 14, an ONT 140 according to the third embodiment of the present invention includes a plurality of Ethernet interface units 141, a TDM (T1/E1) interface unit 142, a switch unit 143 and an EPON interface unit 144.

Each of the Ethernet interface units 141 is connected to the Ethernet, including a subscriber terminal, to transmit and receive Ethernet frames to and from the Ethernet. That is, each of the Ethernet interface units 141 transmits Ethernet frames, received from the Ethernet, to the switch unit 143, and transmits Ethernet frames, received from the switch unit 143, to the Ethernet. The Ethernet interface units 141 and the switch unit 143 are connected to each other through Media Independent Interface (MII), but they can be connected through other interfaces. The number of the Ethernet interface units 141 connected to the switch unit 143 can be increased depending on the number of the ports of the switch unit.

The TDM interface unit 142 converts TDM frames received from the TDM leased line into Ethernet frames and transmits the Ethernet frames to the switch unit 143. The TDM interface unit 142 converts Ethernet frames, received from the switch unit 143, into TDM frames and transmits the TDM frames to the TDM leased line. A T-carrier or E-carrier system is used for the TDM leased line. Any other lines supporting TDM can be used as the TDM leased line. In this case, each TDM frame is a set of data divided into time slots.

The TDM interface unit 142 transmits TDM frames to the TDM leased line in synchronization with the clock of the local exchange 23 so as to precisely transmit or receive TDM frames. A method of obtaining the clock information of the local exchange by the TDM interface unit 142 is divided into a method of receiving the clock information of the local exchange in the form of a packet from the OLT connected to the local exchange of PSTN, and a method of extracting clock information from TDM frames. The TDM interface unit 142 will be described in detail with reference to FIG. 17.

The EPON interface unit 144 interfaces with EPON to transmit Ethernet frames received from the EPON to the switch unit 143, or to transmit Ethernet frames received from the switch unit 143 to the EPON.

The switch unit 143 includes ports connected to the Ethernet interface units 141, the TDM interface unit 142 and the EPON interface unit 143, and transmits Ethernet frames, received from the respective ports, to ports corresponding to the destination addresses of the Ethernet frames.

The switch unit 143 can be implemented with a multiplexer that demultiplexes Ethernet frames, received from the Ethernet interface units 141 and the TDM interface unit 142, and outputs them to the EPON interface unit 144. In the reverse processing, the switch unit 143 multiplexes Ethernet frames received from the EPON interface unit 144 and outputs them to the Ethernet interface units 141 or the TDM interface unit 142. The switch unit 143 and the EPON interface unit 144 are connected to each other through GMII, but they can be connected through other interfaces.

The switch unit 143 allocates a highest priority to Ethernet frames received from the TDM interface unit 142 and Ethernet frames to be output to the TDM interface unit 142. The EPON interface unit 144 transmits Ethernet frames output from the TDM interface unit 142 through a dedicated frequency bandwidth, which has been previously allocated, or in the same manner as that of the typical Ethernet. As a result, the delay problem of the TDM frames is solved.

FIG. 15 is a block diagram showing another example of the construction of an ONT (ONU) in the EPON system according to the third embodiment of the present invention.

Referring to FIG. 15, the ONT 150 of the EPON system according to the third embodiment of the present invention includes a plurality of Ethernet interface units 151, a TDM interface unit 152, a switch unit 153 and an EPON interface unit 154. The constructions and functions of the Ethernet interface units 151 are the same as those of the Ethernet interface units 141, described with reference to FIG. 14, so that a detailed description thereof is omitted.

The construction and function of the TDM interface unit 152 is the same as that of the TDM interface unit 142, described with reference to FIG. 14. However, the connecting relationship of the TDM interface unit 152 is different from that of the TDM interface unit 142 in that it is directly connected to the EPON interface unit 154, not the switch unit 153, differently from FIG. 14. The construction and function of the switch unit 153 is equal to that of the switch unit 143 of FIG. 14, except for the fact that the switch unit 153 is not connected to the TDM interface unit 152 differently from FIG. 4, so that a detailed description thereof is omitted.

The EPON interface unit 154 transmits Ethernet frames received from the EPON to the switch unit 153 and/or the TDM interface unit 152. The EPON interface unit 154 transmits the Ethernet frames output from the TDM interface unit 152 through a previously allocated frequency band. As a result, the delay of TDM frames can be prevented. The EPON interface unit 154 can output the Ethernet frames received from the EPON to both the switch unit 153 and the TDM interface unit 152. However, the EPON interface unit 154 preferably performs a multiplexer function to demultiplex Ethernet frames, received from the switch unit 153 and the TDM interface unit 152, and output the demultiplexed Ethernet frames to the EPON, or multiplex Ethernet frames, received from the EPON, and output the multiplexed Ethernet frames to the switch unit 153 or the TDM interface unit 152. The TDM interface unit 152 and the EPON interface unit 154 are connected to each other through MII or GMII. Further, the TDM interface unit 152 and the EPON interface unit 154 can be connected to each other through interfaces contracted therebetween other than the MII or GMII.

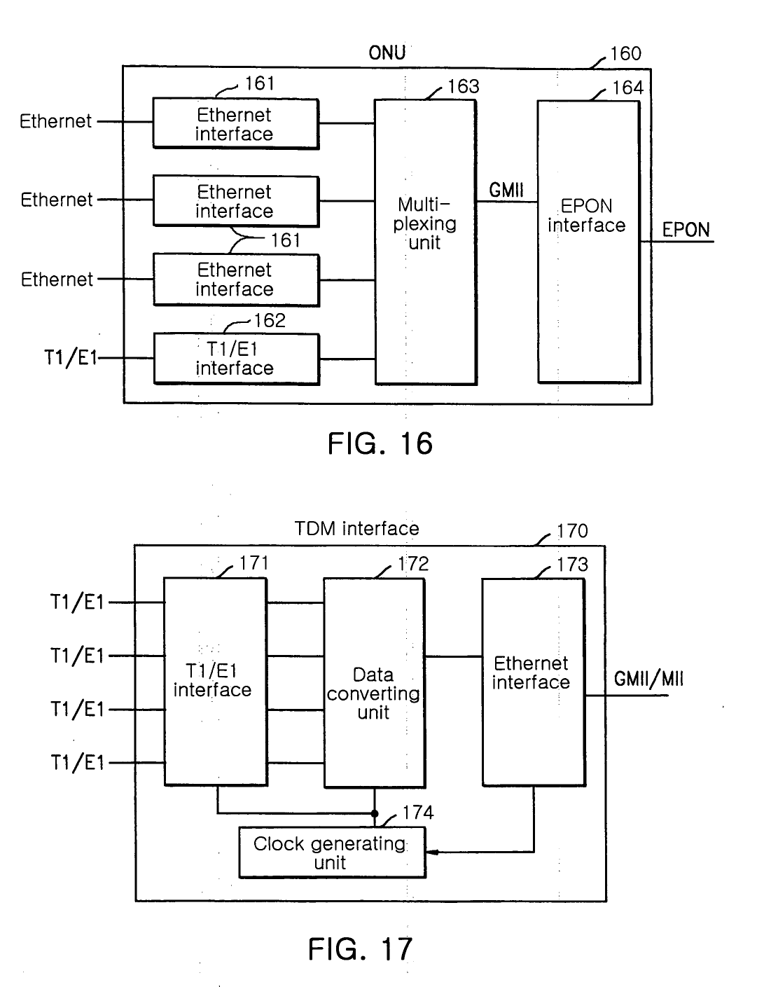

FIG. 16 is a block diagram showing a further example of the construction of an ONT (ONU) in the EPON system according to the third embodiment of the present invention.

Referring to FIG. 16, the ONT 160 includes Ethernet interface units 161, a TDM interface unit 162, a multiplexing unit 163, and an EPON interface unit 164. The functions and constructions of the Ethernet interface units 161, the TDM interface unit 162 and the EPON interface unit 164 are equal to those of the Ethernet interface units 141, the TDM interface unit 142 and the EPON interface unit 144, described with reference to FIG. 14, so that a detailed description thereof is omitted.

The multiplexing unit 163 demultiplexes Ethernet frames, received from the plurality of Ethernet interface units 161 and the TDM interface unit 162, and outputs the demultiplexed Ethernet frames to the EPON interface unit 160. In the reverse processing, the multiplexing unit 163 multiplexes Ethernet frames, received from the EPON interface unit 164, and outputs the multiplexed Ethernet frames to the Ethernet interface units 161 or the TDM interface unit 162.

FIG. 17 is a block diagram showing the detailed construction of a TDM interface unit of components provided in an ONT in the EPON system according to the third embodiment of the present invention.

Referring to FIG. 17, the TDM interface unit includes a T1/E1 interface unit 171, a data converting unit 172, an Ethernet interface unit 173 and a clock generating unit 174.

The T1/E1 interface unit 171 interfaces with TDM leased lines to transmit and receive TDM frames. That is, the T1/E1 interface unit 171 transmits TDM frames received from the TDM leased lines to the data converting unit 172, and outputs TDM frames received from the data converting unit 172 to the TDM leased lines in synchronization with a clock. The clock will be described in detail with reference to the clock generating unit 174. The T1/E1 interface unit 171 interfaces with one or more TDM leased lines T1/E1, and is connected to the data converting unit 172 through the lines, the number of which is equal to that of the TDM leased lines interfacing with the T1/E1 interface unit 171. TDM frames, input to the T1/E1 interface unit 171 through respective TDM leased lines, are output through respective lines connected to the data converting unit 172. The TDM frames, output from the data converting unit 172, are output to the respective TDM leased lines.

The data converting unit 172 converts TDM frames, received from the T1/E1 interface unit 171, into Ethernet frames, and outputs the Ethernet frames to the Ethernet interface unit 173, or converts Ethernet frames, received from the Ethernet interface unit 173, into TDM frames and outputs the TDM frames to the T1/E1 interface unit 171. The configuration of the Ethernet frames for the TDM frames was described above with reference to FIG. 3a. The TDM frames converted by the data converting unit 172 are output to the T1/E1 interface unit 171 in synchronization with the clock. The T1/E1 interface unit 171, having received the TDM frames, outputs the TDM frames to the TDM leased lines in synchronization with the clock.

The clock generating unit 174 generates the clock for the transmission and reception of TDM frames. At this time, the clock generating unit 174 generates the clock on the basis of a clock synchronization packet, including clock information received from the OLT 22 connected to the local exchange 23 of the PSTN 24, or generates the clock by extracting clock information from TDM frames. The clock synchronization packets are periodically transmitted to the ONU 21 by the OLT 22 at regular intervals. Such a clock generating unit 174 is implemented using the construction and method, described with reference to FIG. 6 and FIGS. 7a and 7b.

The Ethernet interface unit 173 is connected to the switch unit 143 to transmit and receive Ethernet frames as in the case of FIG. 14, or directly connected to the EPON interface unit 154 to transmit and receive Ethernet frames, as in the case of FIG. 15. The Ethernet interface unit 173 performs the same function of transmitting and receiving Ethernet frames regardless of which one of the switch unit 143 and the EPON interface unit 154 is connected to the Ethernet interface unit 173. Therefore, the TDM interface unit 170 having the above construction can be separately manufactured and provided in the ONT 21 of FIG. 2.

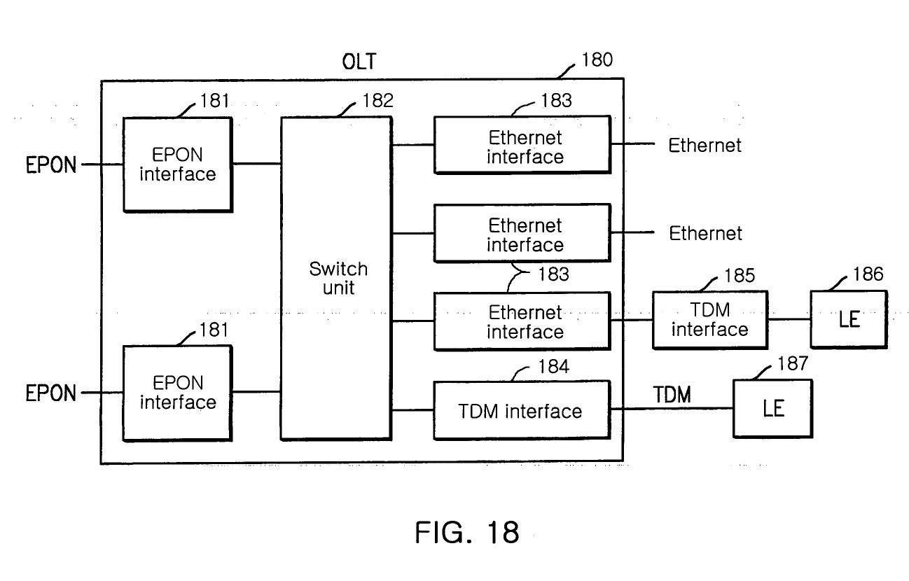

FIG. 18 is a block diagram showing an example of the construction of an Optical Line Terminal (OLT) in the EPON system according to the third embodiment of the present invention.

Referring to FIG. 18, the OLT 180 includes a plurality of EPON interface units 181, a switch unit 182, a plurality of Ethernet interface units 183 and a TDM interface unit 184. The TDM interface unit 184 is connected to the local exchanges 186 and 187 of PSTN. Further, the TDM interface unit 184 is implemented to be included in the OLT 180, or implemented with an externally independent device connected to the Ethernet interface unit 183.

The EPON interface units 181 interface with the EPON to transmit and receive Ethernet frames. That is, the EPON interface units 181 transmit Ethernet frames, received from the EPON, to the switch unit 182, and transmits Ethernet frames, received from the switch unit 182, to the EPON. The OLT 180 of the present invention may include two or more EPON interface units 181, which are connected to the switch unit 182.

The switch unit 182 performs a switching operation with respect to Ethernet frames received from the EPON interface unit 182, Ethernet frames received from the Ethernet interface unit 183 and Ethernet frames received from the TDM interface units 184 and 185. In this case, the switching operation represents an operation of outputting Ethernet frames to a port corresponding to the destination of the Ethernet frames. Generally, in order to detect the port corresponding to the destination, the MAC address of Ethernet frames is used. If Ethernet frames include an IP address, the switch unit 182 may perform the switching operation on the basis of the IP address. The switch unit 182 sets an output sequence so that Ethernet frames received from the TDM interface units 184 and 185 are first output. Accordingly, the delay of the TDM frames can be prevented.

The Ethernet interface unit 183 interfaces with the Ethernet to transmit and receive Ethernet frames. The Ethernet includes the high-speed Ethernet, that is, Gigabit Ethernet (GE/10GE), as well as the low-speed Ethernet. The Ethernet interface unit 183 interfaces with the Ethernet depending on respective Ethernet protocols.

The TDM interface units 184 and 185 convert Ethernet frames received from the switch unit 182 into TDM frames and output the TDM frames to the TDM leased lines. Further, the TDM interface units 184 and 185 convert TDM frames received from the TDM leased lines into Ethernet frames, and output the Ethernet frames to the switch unit 182. The TDM interface units 184 and 185 are connected to the local exchanges 186 and 187 of the PSTN through the TDM leased lines. The TDM interface units 184 and 185 can be connected to the switch unit 182 and implemented in the OLT 180, or connected to the Ethernet interface unit 183 and implemented separately from the OLT 180.

The EPON interface units 181, the switch unit 182, the Ethernet interface unit 183, and the TDM interface units 184 and 185 are connected to each other through GMII, but they can be connected through other interfaces.

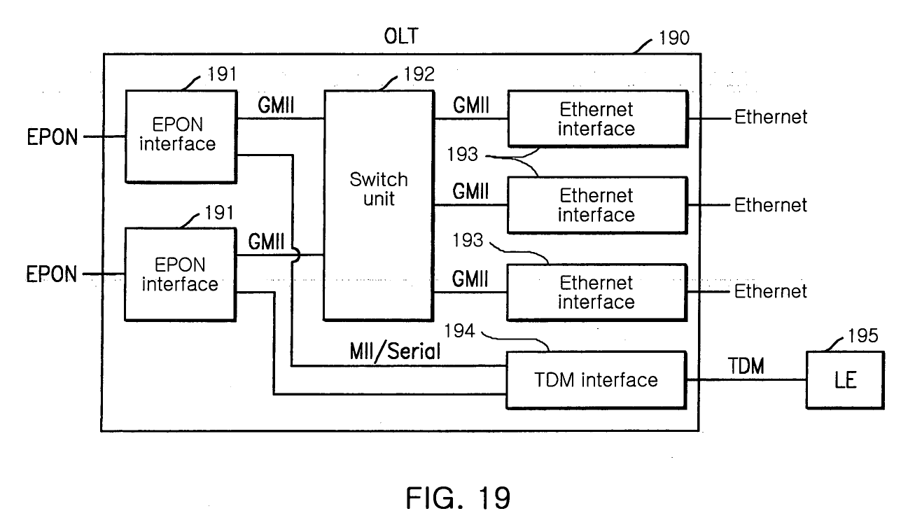

FIG. 19 is a block diagram showing another example of the construction of an OLT in the EPON system according to the third embodiment of the present invention.

Referring to FIG. 19, an OLT 190 includes EPON interface units 191, a switch unit 192, Ethernet interface units 193, and a TDM interface unit 194. The TDM interface unit 194 is connected to the local exchange 195 of PSTN through a TDM leased line.

The EPON interface units 191 interface with the EPON to transmit and receive Ethernet frames. That is, each of the EPON interface units 191 transmits Ethernet frames received from the EPON to the switch unit 192 or the TDM interface unit 194, and transmits Ethernet frames received from the switch unit 192 or the TDM interface unit 194 to the EPON. Two or more EPON interface units 191 may be provided in the OLT 190 of the present invention. Each of the EPON interface units 191 multiplexes Ethernet frames received from the EPON and transmits the multiplexed Ethernet frames to the switch unit 192 or the TDM interface unit 194. When transmitting the Ethernet frames received from the TDM interface unit 194 to the EPON, each of the EPON interface units 191 outputs the Ethernet frames through a preset dedicated frequency band, thus preventing the delay of the TDM frames.

The switch unit 192 outputs Ethernet frames received from the EPON interface units 191 and Ethernet frames received from the Ethernet interface units 193 to ports connected to the destinations of the Ethernet frames. The switching operation of the switch unit 192 is performed on the basis of the MAC or IP addresses of the Ethernet frames. If the destinations of the received Ethernet frames are not known, the switch unit 192 performs broadcasting to output Ethernet frames to all ports except for a port through which the Ethernet frames are received. When the switch unit 192 performs the broadcasting, the TDM interface unit 194 is not affected by the broadcasting because it is not connected to the switch unit 192.

The TDM interface unit 194 converts Ethernet frames received from the EPON interface units 191 into TDM frames and outputs the TDM frames to the TDM leased line, and, in the reverse processing, converts TDM frames received from the TDM leased line into Ethernet frames and outputs the Ethernet frames to the EPON interface units 191. The TDM interface unit 94 converts the Ethernet frames into the TDM frames using Pulse Code Modulation (PCM). The TDM interface unit 194 can be implemented in the OLT, or implemented outside the OLT 190 while being connected to the Ethernet interface units 193.

The Ethernet interface units 193 have the same constructions and functions as the Ethernet interface units, described with reference to FIG. 18.

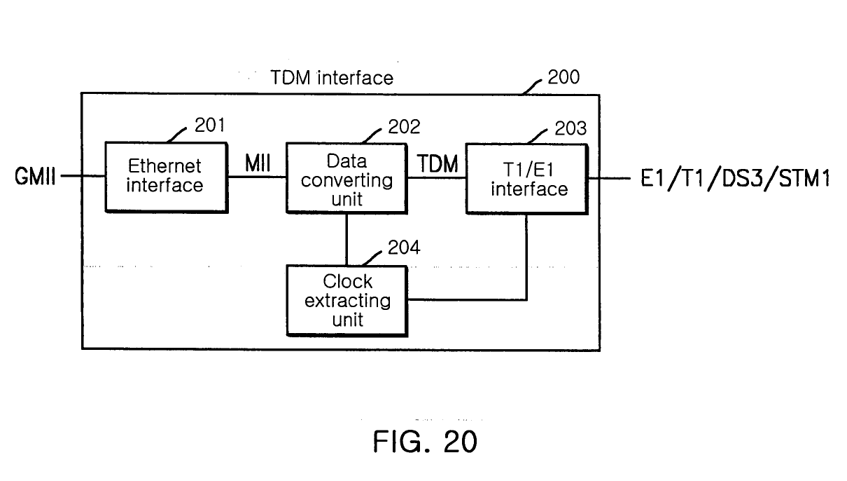

FIG. 20 is a block diagram showing an example of the construction of a TDM interface unit provided in the OLT of the EPON system according to the third embodiment of the present invention.

Referring to FIG. 20, a TDM interface unit 200 of the present invention includes an Ethernet interface unit 201, a data converting unit 202, a T1/E1 interface unit 203 and a clock extracting unit 204.

The Ethernet interface unit 201 transmits externally received Ethernet frames to the data converting unit 202, or outputs Ethernet frames received from the data converting unit 202 to the outside of the TDM interface unit 200. The Ethernet interface unit 201 can be connected to the data converting unit 202 through a plurality of MIIs. If the Ethernet interface unit 201 is connected to the data converting unit 202 through the plurality of interfaces, it performs multiplexing/demultiplexing functions. The T1/E1 interface unit 203 interfaces with the TDM leased line to transmit and receive TDM frames. A T1/E1/Digital Signal Level 3 (DS3)/Synchronous Transport Module level 1 (STM1) line can be used as the TDM leased line.

The data converting unit 202 converts Ethernet frames received from the Ethernet interface unit 201 into TDM frames and transmits the TDM frames to the T1/E1 interface unit 203, or converts TDM frames received from the T1/E1 interface unit 203 into the Ethernet frames and outputs the Ethernet frames to the Ethernet interface unit 201. The Ethernet interface unit 201 is connected to the switch unit 182 of FIG. 18 or the EPON interface unit 191 of FIG. 19.

The clock extracting unit 204 extracts clock information from received TDM frames. The data converting unit 202 generates a clock synchronization packet on the basis of the clock information extracted by the clock extracting unit 204. The generated clock synchronization packet is loaded on an Ethernet frame or a separate clock synchronization frame, and then transmitted to the ONT.

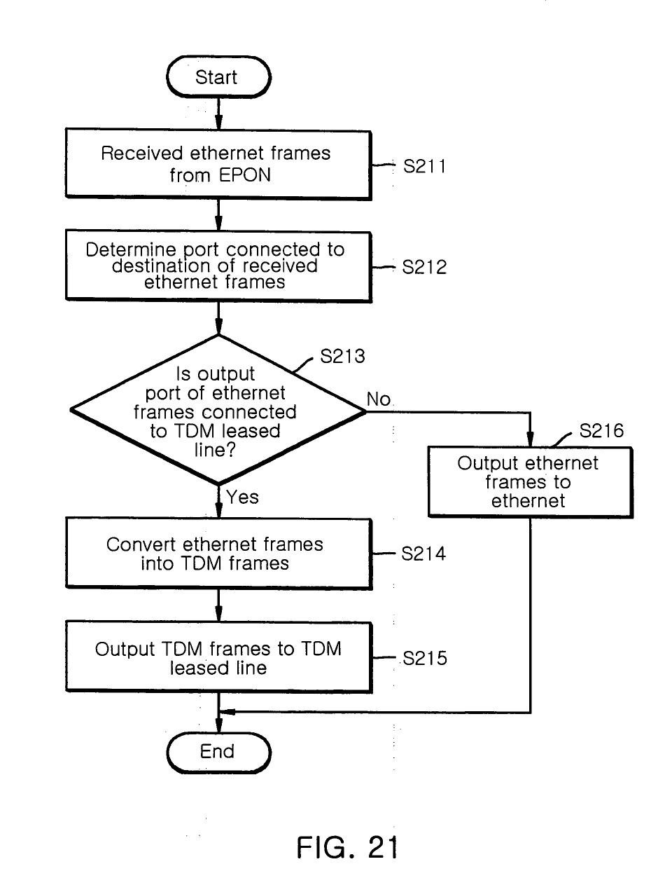

FIG. 21 is a flowchart of a procedure of accommodating TDM leased lines in the ONT of the present invention.

Referring to FIG. 21, the EPON interface unit 144 receives Ethernet frames from the EPON at step 211. The EPON interface unit 144 transmits and receives Ethernet frames through a previously allocated frequency band. Data, received by the TDM interface unit 142 from TDM leased lines and converted into Ethernet frames, are transmitted through a frequency band previously allocated by the EPON interface unit 144, thus preventing the delay of data.

The switch unit 143 determines an output port on the basis of the destination address of the Ethernet frames the EPON interface unit 144 has received at step 212.

If the Ethernet frames are output to a port connected to the TDM leased line at step S213, the data converting unit 172 converts the Ethernet frames into TDM frames at step S214. A procedure of converting the Ethernet frames into the TDM frames uses Pulse Code Modulation (PCM).

Further, the T1/E1 interface unit 171 outputs the TDM frames to the TDM leased line at step S215. The clock generating unit 174 generates a clock on the basis of a clock synchronization packet transmitted from the OLT, and the T1/E1 interface unit 171 outputs the TDM frames to the TDM leased line in synchronization with the generated clock at step S215.

If the Ethernet frames are output to a port connected to the Ethernet by the switch unit 143 at step S213, the Ethernet interface unit 141 outputs the Ethernet frames to the Ethernet at step S216.

The above process is described with respect to a data flow from the EPON to the Ethernet subscriber or TDM leased line subscriber. A reverse data flow reverse to the above process can be implemented by performing the corresponding operations in the reverse order.

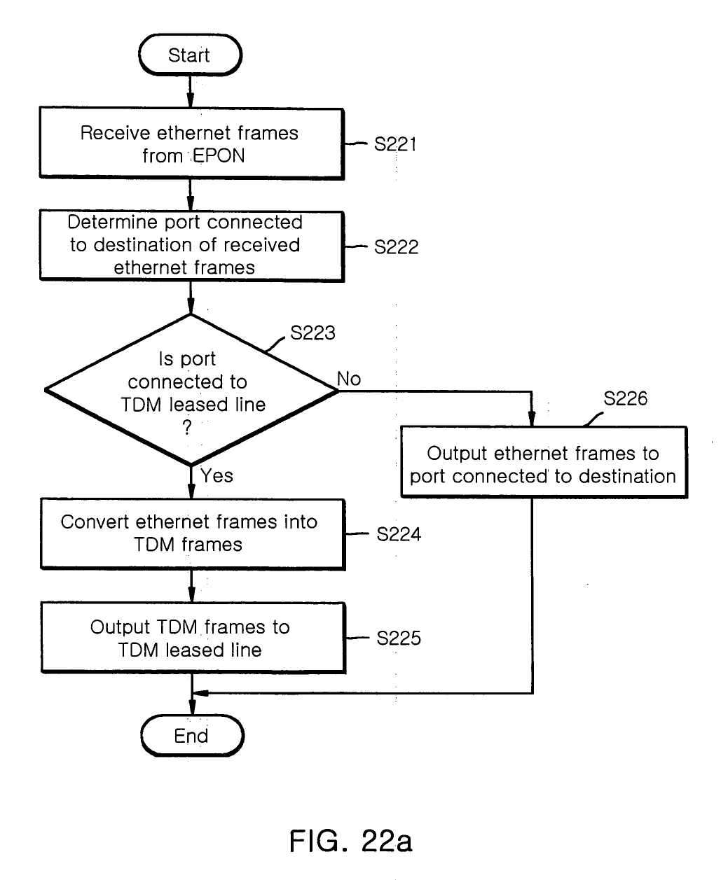

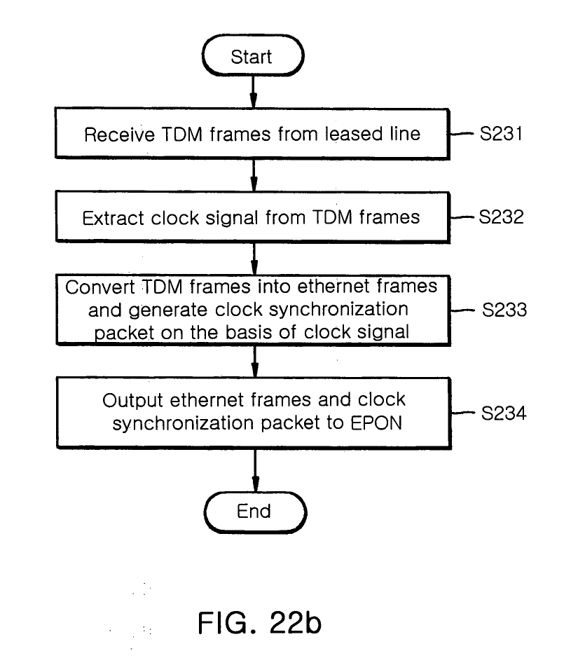

FIG. 22a is a view showing a process of accommodating TDM leased lines in the OLT according to the third embodiment of the present invention.

Referring to FIG. 22a, the EPON interface unit 181 receives Ethernet frames from the EPON through a frequency band previously allocated for TDM frames at step S221.

The switch unit 182 determines any one of a port connected to the Ethernet and a port connected to the TDM leased line as an output port on the basis of the destination address of the received Ethernet frames at step S222.

If the Ethernet frames are output to the port connected to the TDM leased line at step S223, the data converting unit 202 converts the Ethernet frames into TDM frames at step S224. In this case, the data converting unit 202 converts the Ethernet frames into the TDM frames using PCM. The T1/E1 interface unit 203 outputs the TDM frames to the TDM leased line at step S225. The T1/E1 interface unit 203 is connected to the local exchange of the PSTN.

In contrast, if the Ethernet frames are output to the port connected to the Ethernet at step S223, the Ethernet interface unit 183 outputs the Ethernet frames to the Ethernet.

FIG. 22b is a view showing another process of accommodating TDM leased lines in the OLT of the EPON system according to the third embodiment of the present invention.

Referring to FIG. 22b, the T1/E1 interface unit 203 receives TDM frames from the TDM leased line at step S231. The T1/E1 interface unit 203 is connected to the local exchange of the PSTN through the TDM leased line. Further, the clock extracting unit 204 extracts a clock signal from the received TDM frames at step S232.

The data converting unit 201 converts the received TDM frames into Ethernet frames, and generates a clock synchronization packet, including clock information of the local exchange, on the basis of the extracted clock signal at step S233. The EPON interface unit 181 outputs the Ethernet frames and the clock synchronization packet to the EPON at step S234. The EPON outputs the Ethernet frames through a unique frequency band allocated to the Ethernet frames, thus preventing delays when transmitting the Ethernet frames.

As described above, the present invention provides an Ethernet Passive Optical Network (EPON) system, which allows an optical network terminal (or an optical network unit) located at the subscriber side of the Ethernet to accommodate together TDM subscribers and/or VDSL subscribers, thus coding POTS traffic into digital data, converting the digital data into packets and transmitting the packets to the Ethernet, and thus converting TDM leased line data into packets and transmitting the packets to the Ethernet. Therefore, the present invention can service even POTS signals and TDM traffic together with the data traffic through the single Ethernet. As a result, the present invention is advantageous in that it integrates the access networks of subscribers, desiring high-speed data services, POTS and TDM services, into a single access network, thus reducing the installation and operation costs of the subscriber access networks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An Ethernet Passive Optical Network (EPON) system, in which subscriber access networks for at least two of an Ethernet subscriber, a Plan Old Telephone Service (POTS) subscriber, a Very-High-Data-Rate Digital Subscriber Line (VDSL) subscriber and a Time Division Multiplexing (TDM) leased line subscriber are connected to a Packet Switched Data Network (PSDN) and a Packet Switched telephone Network (PSTN), comprising:
a plurality of optical network terminals each connected to two or more subscriber access networks to perform Ethernet switching for Ethernet frames received from the subscriber access networks and transmit upwardly the Ethernet frames, to convert POTS signals into digital signals and collect a plurality of POTS signals to configure Ethernet frames, and to collect TDM data by a predetermined unit to configure Ethernet frames and transmit upwardly the Ethernet frames, the optical network terminals each separating Ethernet frames received through an optical cable into Ethernet data, POTS data and TDM data, reversely executing the above process, and then transmitting results obtained from the process to a corresponding subscriber access network;
an optical line terminal physically connected to an end of the PSDN and a local exchange of the PSTN and adapted to receive Ethernet frames from the optical network terminals, restore POTS signals and TDM data from the Ethernet frames, transmit the POTS signals and the TDM data to the local exchange, and forward Ethernet data to the PSDN, the optical line terminal, in reverse processing, receiving analog signals and data from the PSDN and the local exchange, transmitting Ethernet data of the received signals and data to the optical network terminals without change, collecting POTS signals and TDM data by a predetermined unit to configure Ethernet frames, and transmitting the Ethernet frames to the optical network terminals; and
an optical cable connecting the optical line terminal and the plurality of optical network terminals to allow the Ethernet frames to be transmitted therebetween.

2. The EPON system according to claim 1, wherein the Ethernet frames transmitted and received between the optical network terminals and the optical line terminal are each comprised of an Ethernet Media Access Control (MAC) field indicating an Ethernet MAC address, a synchronization information field loaded with synchronization information of the local exchange of the PSTN, a plurality of channel fields loaded with POTS traffic or TDM data, and a Frame Check Sequence (FCS) field loaded with information for error detection.

3. The EPON system according to claim 1, wherein the optical line terminal generates and transmits a synchronization packet comprised synchronization information at a certain period,
the optical network terminal receives a synchronization packet from the optical line terminal and observe synchronization information, compares it with a reference clock at a update period, synchronizes the reference clock to a clock of local exchange.

4. The EPON system according to claim 1, wherein the optical network terminals each comprises:
an EPON interface unit connected to the EPON to transmit upstream data and receive downstream data;
an Ethernet switch connected to the EPON interface unit to switch the upstream data and the downstream data depending on destinations;
a VDSL splitter connected to the subscriber access network of the VDSL subscriber to separate VDSL signals and POTS signals, received from the subscriber access network, or multiplex VDSL data and POTS signals of the downstream data received from the Ethernet switch and transmit the multiplexed results to the VDSL subscriber access network;
a VDSL interface unit disposed between the VDSL splitter and the Ethernet switch, to convert the VDSL data into Ethernet frames, convert input Ethernet frames into VDSL data, and transmit the Ethernet frames or the VDSL data; and
a TDM interface unit collecting POTS signals received from the POTS subscriber access network and the VDSL splitter, and TDM data received from a TDM leased line by a predetermined unit, respectively, converting the collected signals and data into Ethernet frames and transmitting the Ethernet frames to the Ethernet switch, and, in reverse processing, restoring POTS signals and TDM data from data received from the Ethernet switch, respectively, and transmitting the POTS signals and the TDM data to corresponding subscriber access networks.

5. The EPON system according to claim 1, wherein the optical line terminal comprises:
an EPON interface unit connected to one or more optical cables to interface with one or more optical network terminals and transmit and receive Ethernet frames to and from the optical network terminals;
an Ethernet switch switching Ethernet frames received through the EPON interface unit to the PSDN or PSTN, and switching Ethernet frames received from the PSDN or PSTN to corresponding subscribers;
one or more Ethernet interface units connected to the PSDN to interface between the Ethernet switch and the PSDN; and
a TDM interface unit disposed between the Ethernet switch or the Ethernet interface units and the local exchange of the PSTN to interface between the Ethernet switch or the Ethernet interface units and the local exchange.

6. The EPON system according to claim 4, wherein the TDM interface unit comprises:
a POTS interface unit interfacing with the POTS subscriber access network to convert POTS signals into digital signals, collect the digital signals by a predetermined unit to configure Ethernet frames, output the Ethernet frames to the Ethernet switch, extract POTS data from input Ethernet frames, convert the POTS data into analog signals, and transmit the analog signals to the POTS subscriber access network;
a T1/E1 interface unit interfacing with the TDM leased line T1/E1 to receive and output TDM data;
a TDM/Ethernet converting unit collecting POTS data and TDM data received from the POTS interface unit and the T1/E1 interface unit by a predetermined unit, respectively, to configure Ethernet frames, extracting POTS data and TDM data from input Ethernet frames, and outputting the POTS data and TDM data to the POTS interface unit and the T1/E1 interface unit, respectively, the TDM/Ethernet converting unit extracting synchronization information of the local exchange from the Ethernet frames and transmitting the synchronization information to a clock synchronizing unit; and
clock synchronizing unit synchronizing reference clocks of the POTS interface unit and the T1/E1 interface unit with each other in response to the synchronization information received from the TDM/Ethernet converting unit, thus performing signaling and initialization of the optical network terminals.

7. The EPON system according to claim 6, wherein the POTS interface unit comprises:
a plurality of overvoltage detection circuits eliminating an overvoltage flowing from a corresponding subscriber line to protect a circuit;
a plurality of subscriber line interface circuits supplying power to a corresponding subscriber line and performing on-hook/off-hook and ring trip detection;
a plurality of Coders-Decoders (Codecs) modulating analog signals input from the subscriber line into digital signals, or demodulating input digital signals into analog signals and transmitting the analog signals to the subscriber line;
a call signal generator generating a call signal with a frequency of 20 Hz to be transmitted to a normal telephone and transmitting the call signal to the subscriber line; and
a PCM/Ethernet converting unit collecting POTS signals digital-modulated by the plurality of Codecs to configure Ethernet frames, extracting modulated POTS signals from input Ethernet frames and transmitting the modulated POTS signals to corresponding Codecs.

8. The EPON system according to claim 6, wherein the clock synchronizing unit comprises:
a frequency comparator comparing a local clock of the clock synchronizing unit with the synchronization information of the local exchange extracted by the TDM/Ethernet converting unit;
a digital-to-analog converter converting a comparison value output from the frequency comparator into a voltage signal;
a Voltage Controlled Crystal Oscillator (VCXO) receiving the voltage signal output from the digital-to-analog converter as a tuning voltage, and oscillating at a frequency corresponding to the tuning voltage; and
a Phase Locked Loop (PLL) generating a clock signal phase-matched with the frequency output from the VCXO and applying the clock signal to the POTS interface unit, the T1/E1 interface unit and the frequency comparator.

9. The EPON system according to claim 4 or 5, wherein the Ethernet switch allocates a higher priority to TDM traffic than data traffic to perform a switching operation.

10. An optical network terminal of an Ethernet Passive Optical Network (EPON) system, which is connected to subscriber lines for at least two of an Ethernet subscriber, a Plan Old Telephone Service (POTS) subscriber and a Very-High-Data-Rate Digital Subscriber Line (VDSL) subscriber to connect to a Packet Switched Data Network (PSDN) and a Packet Switched telephone Network (PSTN), comprising:
VDSL splitters connected to VDSL subscriber lines, respectively, to separate input VDSL signals into data traffic and POTS signals, multiplex the data traffic and the POTS signals through different bands, and transmit the multiplexed results to corresponding subscriber lines;
one or more VDSL interface units receiving the data traffic separated by the plurality of VDSL splitters to configure and output Ethernet frames, or extracting data traffic from input Ethernet frames, modulating the data traffic into VDSL signals, and transmitting the VDSL signals to corresponding VDSL splitters;
a POTS interface unit coding the POTS signals separated by the VDSL splitters into respective digital signals and collecting the digital signals by a predetermined unit to configure Ethernet frames, or extracting a plurality of digital POTS signals from input Ethernet frames, demodulating the digital POTS signals into analog signals, and transmitting the analog signals to corresponding VDSL splitters;
an Ethernet switch switching and outputting Ethernet frames, output from the plurality of VDSL modules and the POTS interface unit, to an EPON, and switching Ethernet frames, received from the EPON, to the VDSL interface units and the POTS interface unit corresponding to destinations of the Ethernet frames; and
an EPON interface unit interfacing with the EPON to transmit and receive data to and from the Ethernet switch.

11. The optical network terminal according to claim 10, wherein the Ethernet switch allocates a higher priority to POTS traffic than data traffic to perform a switching operation.

12. The optical network terminal according to claim 10, wherein the POTS interface unit comprises:
a plurality of overvoltage protection circuits eliminating an overvoltage flowing from a corresponding VDSL subscriber line to protect a circuit;
a plurality of subscriber line interface circuits supplying power to a corresponding VDSL subscriber line and performing on-hook/off-hook and ring trip detection;
a plurality of Codecs modulating analog signals separated by the VDSL splitters into digital signals, or demodulating input digital signals into analog signals;
a call signal generator generating a call signal with a frequency of 20 Hz to be transmitted to a normal telephone connected to the VDSL subscriber line and transmitting the call signal to the VDSL subscriber line;
a microprocessor initializing the POTS modules, and controlling generation and stopping of signaling in response to detection signals output from the subscriber line interface circuits and messages received from the EPON;
a clock generator comparing a synchronization packet received from the EPON with a reference clock to generate a clock synchronized with the local exchange of the PSTN, and providing the clock to the corresponding devices; and
a PCM/Ethernet converting unit collecting POTS signals modulated by the plurality of Codecs to configure Ethernet frames and then transmitting the Ethernet frames to the Ethernet switch, and extracting POTS traffic from Ethernet frames input from the Ethernet switch and then transmitting the POTS traffic to corresponding Codecs.

13. The optical network terminal according to claim 10, wherein the Ethernet frames of the PCM/Ethernet converting unit are each comprised of an Ethernet MAC field indicating an Ethernet MAC address, an Internet Protocol/User Datagram Protocol (IP/UDP) field indicating IP/UDP addresses of destinations, a plurality of channel fields loaded with modulated POTS signals, and a Frame Check Sequence (FCS) field loaded with information for error detection.

14. An optical network terminal of an Ethernet Passive Optical Network (EPON) system, which is connected to subscriber lines for at least two of an Ethernet subscriber, a Plan Old Telephone Service (POTS) subscriber and a Very-High-Data-Rate Digital Subscriber Line (VDSL) subscriber to connect to a Packet Switched Data Network (PSDN) and a Packet Switched telephone Network (PSTN), comprising:
one or more VDSL splitters connected to VDSL subscriber lines, respectively, to separate input VDSL signals into data traffic and POTS signals, and, in reverse processing, to multiplex input data traffic and POTS traffic and transmit the multiplexed results to corresponding subscriber lines;
one or more VDSL interface units receiving the data traffic separated by the plurality of VDSL splitters to configure and output Ethernet frames, and, in reverse processing, extracting VDSL data traffic and POTS traffic from input Ethernet frames, demodulating the VDSL data traffic and the POTS traffic, and transmitting the demodulated results to corresponding VDSL splitters;
a POTS interface unit coding the POTS signals separated by the VDSL splitters into respective digital signals, collecting the coded POTS traffic by a predetermined unit to configure Ethernet frames and outputting the Ethernet frames to an EPON interface unit, and, in reverse processing, extracting POTS traffic from input Ethernet frames, decoding the POTS traffic into analog signals, and transmitting the analog signals to corresponding VDSL splitters;
an Ethernet switch switching Ethernet frames, transmitted and received to and from the plurality of VDSL interface units, to destinations; and
the EPON interface unit interfacing with the EPON to transmit Ethernet frames input to the Ethernet switch and the POTS interface unit to the EPON depending on priorities, and to transmit downstream data received from the EPON to the Ethernet switch or the POTS interface unit,
wherein the optical network terminal separates routes of data traffic and POTS traffic, thus minimizing delay of the POTS traffic.

15. An optical network terminal of an Ethernet Passive Optical Network (EPON) system, which is connected to subscriber lines of an Ethernet subscriber and a Time Division Multiplexing (TDM) leased line subscriber to connect to local exchanges of a Packet Switched Data Network (PSDN) and a Packet Switched telephone Network (PSTN), comprising:
a T1/E1 interface unit interfacing with the subscriber line of the TDM leased line subscriber to transmit and receive TDM frames in synchronization with a predetermined reference clock;
an Ethernet interface unit interfacing with the EPON to transmit and receive Ethernet frames to and from the EPON;
a data converting unit converting TDM data output from the T1/E1 interface unit into Ethernet frames and outputting the Ethernet frames, and, in reverse processing, demodulating input Ethernet frames into TDM frames and outputting the TDM frames to the TDM interface unit; and
a clock generating unit generating a clock synchronized with the local exchange on the basis of clock synchronization information for the local exchange of the PSTN included in the Ethernet frames received through the Ethernet interface unit, and providing the clock to both the T1/E1 interface unit and the data converting unit as a reference clock.

16. The optical network terminal according to claim 15, further comprising an EPON interface unit interfacing with the EPON to output Ethernet frames, received from the EPON, to a port connected to the Ethernet interface unit or the Ethernet, and transmit Ethernet frames, received from the port connected to the Ethernet interface unit and the Ethernet, through unique frequency bands of the Ethernet frames.

17. The optical network terminal according to claim 15, further comprising:
an Ethernet switch including a first port connected to the Ethernet, a second port connected to the Ethernet interface unit and a third port connected to the EPON, the Ethernet switch determining an output port on the basis of destination addresses of the Ethernet frames received from the first to third ports; and
an EPON interface unit disposed between the third port and the EPON to transmit and receive the Ethernet frames.

18. The optical network terminal according to claim 17, wherein the Ethernet switch processes Ethernet frames, loaded with TDM traffic input/output from/to the second port, with highest priority.

19. An optical line terminal of an Ethernet Passive Optical Network (EPON) system, which is provided at an end of an EPON and connected to local exchanges of a Packet Switched Data Network (PSDN) and a Packet Switched telephone Network (PSTN), comprising:
a T1/E1 interface unit interfacing with a TDM leased line connected to the local exchange of the PSTN to transmit and receive TDM frames;
a clock extracting unit extracting a clock from TDM frames input through the T1/E1 interface unit;
a data converting unit exchanging TDM frames received from the T1/E1 interface unit into Ethernet frames, and generating clock synchronization information on the basis of the clock extracted by the clock extracting unit; and
an Ethernet interface unit outputting the clock synchronization information generated by the data converting unit and the Ethernet frames.

20. The optical line terminal according to claim 19, further comprising an EPON interface unit interfacing with the EPON to output Ethernet frames, received from the EPON, to a port connected to the Ethernet interface unit or the Ethernet, and transmit Ethernet frames, received from the port connected to the Ethernet interface unit and the Ethernet, through unique frequency bands of the Ethernet frames.

21. The optical line terminal according to claim 19, further comprising:
an Ethernet switch including a first port connected to the Ethernet, a second port connected to the Ethernet interface unit and a third port connected to the EPON, the Ethernet switch determining an output port on the basis of destination addresses of the Ethernet frames received from the first to third ports; and
an EPON interface unit disposed between the third port and the EPON to transmit and receive the Ethernet frames to and from the EPON.

22. The optical line terminal according to claim 21, wherein the Ethernet switch processes Ethernet frames, loaded with TDM traffic input/output from/to the second port, with highest priority.
